(19) United States
(12) Patent Application Publication
(10) Pub. No.: US 2025/0016872 A1
(43) Pub. Date: Jan. 9, 2025

(54) ENHANCEMENT FOR SINGLE-TRANSMIT RECEIVE POINT (S-TRP) SEPARATE UPLINK POWER CONTROL AND UNIFIED TRANSMISSION CONFIGURATION INDICATOR (TCI) STATES FOR SUB-BAND FULL DUPLEX (SBFD) AND NON-SBFD SYMBOLS

(71) Applicant: QUALCOMM Incorporated, San Diego, CA (US)

(72) Inventors: Qian ZHANG, Basking Ridge, NJ (US); Yan ZHOU, San Diego, CA (US); Jelena DAMNJANOVIC, Del Mar, CA (US); Jae Ho RYU, San Diego, CA (US); Mostafa KHOSHNEVISAN, San Diego, CA (US); Junyi LI, Greentown, PA (US); Changhwan PARK, San Diego, CA (US); Tao LUO, San Diego, CA (US)

(21) Appl. No.: 18/886,681

(22) Filed: Sep. 16, 2024

Related U.S. Application Data
(63) Continuation-in-part of application No. 18/514,685, filed on Nov. 20, 2023.
(60) Provisional application No. 63/385,573, filed on Nov. 30, 2022.

(51) Int. Cl. H04W 76/20; H04L 5/14; H04W 52/08; H04W 72/231; H04W 72/51

(52) U.S. Cl. CPC H04W 76/20; H04L 5/14; H04W 52/08; H04W 72/231; H04W 72/51

(57) ABSTRACT

Certain aspects of the present disclosure provide a method for wireless communications at a user equipment (UE). The UE may receive a configuration from a base station (BS). The configuration may indicate transmission parameters associated with different symbols such as sub-band full duplex (SBFD) symbols and non-SBFD symbols. For example, the transmission parameters may indicate power control parameters (e.g., a received power target value, a power control factor value, a closed-loop power control value) and a unified transmission configuration indicator (TCI) (e.g., a joint uplink and downlink TCI state, separate uplink and downlink TCI states). The UE may transmit uplink transmissions to the BS, in accordance with the transmission parameters.

### CROSS-REFERENCE TO RELATED APPLICATIONS

This application is a continuation-in-part (CIP) of U.S. patent application Ser. No. 18/514,685, filed Nov. 20, 2023, which claims the benefit of U.S. Provisional Application No. 63/385,573, filed Nov. 30, 2022, all of which are incorporated herein by reference in their entireties.

### BACKGROUND

### Field of the Disclosure

Aspects of the present disclosure relate to wireless communications, and more particularly, to techniques for managing uplink transmissions on sub-band full duplex (SBFD) and non-SBFD symbols.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes obtaining (e.g., from a network entity) a configuration indicating one or more transmission parameters associated with full duplex (FD) symbols and non-FD symbols. The one or more transmission parameters indicate at least one of power control parameters or a unified transmission configuration indicator (TCI). The method further includes outputting (e.g., to the network entity) one or more uplink channels for transmission, in accordance with the obtained configuration.

Another aspect provides a method for wireless communications at a network entity. The method includes outputting (e.g., to a UE) a configuration indicating one or more transmission parameters associated with FD symbols and non-FD symbols. The one or more transmission parameters indicate at least one of power control parameters or a unified TCI. The method further includes obtaining (e.g., from the UE) one or more uplink channels, in accordance with the outputted configuration.

The terms “unified TCI” and “unified TCI state(s)” and may be interchangeably used in the following description.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5, FIG. 6, FIG. 7, and FIG. 8 depict different use cases for full-duplex (FD) communications.

FIG. 9 depicts example FD operation at a gNodeB (gNB).

FIG. 10 and FIG. 11 depict example sub-band full duplex (SBFD) slots.

FIG. 12 depicts an example unified transmission configuration indicator (TCI) state activation/deactivation medium access control—control element (MAC-CE).

FIG. 13 depicts a call flow diagram illustrating example communication among wireless nodes (e.g., a UE and a gNB) for managing uplink transmissions on SBFD symbols and non-SBFD symbols.

FIG. 14 depicts non-SBFD power control parameters being used for one physical uplink shared channel (PUSCH) transmission associated with a TCI state and SBFD power control parameters being used for another PUSCH transmission associated with the same TCI state.

FIG. 15 depicts SBFD power control parameters being used for a PUSCH transmission associated with a first TCI state and another PUSCH transmission associated with a second TCI state.

FIG. 16 depicts an example table illustrating mapping of TCI code points and TCI states.

FIG. 17 depicts another example table illustrating mapping of TCI code points and TCI states.

FIG. 18 depicts an example MAC-CE including at least a bit field (Tᵢ) per code point.

FIG. 19 depicts an example table illustrating mapping of TCI code points, TCI states, and duplex indicators.

FIG. 20 depicts another example table illustrating mapping of TCI code points and TCI states.

FIG. 21 depicts an example MAC-CE including at least a control resource set (CORESET) pool identification (ID) field.

FIG. 22 depicts an example table illustrating mapping of TCI code points and TCI states based on a first value (e.g., 1) of a CORESET pool ID.

FIG. 23 depicts an example table illustrating mapping of TCI code points and TCI states based on a second value (e.g., 0) of a CORESET pool ID.

FIG. 24 depicts an example MAC-CE including at least a bit field (F_{i,j}).

FIG. 25 depicts another example table illustrating mapping of TCI code points and TCI states.

FIG. 26 depicts an example MAC-CE including at least a first bit field (F_{i,j}) and a second bit field (S_{i,j}).

FIG. 27 depicts another example table illustrating mapping of TCI code points and TCI states.

FIG. 28 depicts a method for wireless communications at a wireless node such as a UE for managing uplink transmissions on SBFD symbols and non-SBFD symbols.

FIG. 29 depicts a method for wireless communications at a wireless node such as a network entity for managing uplink transmissions on SBFD symbols and non-SBFD symbols.

FIG. 30 and FIG. 31 depict example communications devices for managing uplink transmissions on SBFD symbols and non-SBFD symbols.

### DETAILED DESCRIPTION

Aspects of the present disclosure provide apparatuses, methods, processing systems, and computer-readable mediums for managing uplink transmissions on full duplex (FD) symbols (e.g., sub-band full duplex (SBFD) symbols) and non-FD/non-SBFD symbols.

FD communication refers to a mode of communication where signals can be transmitted and received simultaneously over a single communication channel. For example, in a FD mode, simultaneous transmission between wireless nodes (e.g., a user equipment (UE) and a gNodeB (gNB)) may occur (e.g., in a same slot or a same symbol). In a half duplex (HD) mode, communication flows in one direction (e.g., only downlink communication or only uplink communication) at a given time (e.g., in a given slot or a given symbol).

SBFD refers to a mode where a time division duplex (TDD) carrier is split into sub-bands to enable simultaneous transmission and reception (e.g., on different sub-bands) in a same slot that consists of multiple symbols. For example, in an SBFD mode, the UE may transmit an uplink communication to the gNB and receive a downlink communication from the gNB at a same time, but on different frequency resources. The different frequency resources may be the sub-bands of a frequency band. The frequency resources used for the downlink communication may be separated from the frequency resources used for the uplink communication, in a frequency domain, by a guard band.

An SBFD symbol may refer to a symbol in which an SBFD format is used. The SBFD format may include a format in which FD communications are supported (e.g., for both uplink and downlink communications at a same time). A non-SBFD symbol may refer to a symbol in which only downlink communications or only uplink communications are supported at a given time.

To enable the UE to transmit the uplink transmissions on the SBFD symbols and the non-SBFD symbols, techniques described herein provide transmission parameters to be applied for the uplink transmissions on the SBFD symbols and the non-SBFD symbols. For example, the gNB may configure and indicate to the UE separate uplink power control parameters applicable for the uplink transmissions on the SBFD symbols and the non-SBFD symbols. In another example, the gNB may configure and indicate to the UE separate unified transmission configuration indicator (TCI) states applicable for the uplink transmissions on the SBFD symbols and the non-SBFD symbols (e.g., to implicitly enable different beams, different uplink power control parameters in the SBFD symbols and the non-SBFD symbols).

Particular aspects of the subject matter described in this disclosure can be implemented to realize one or more of the following potential advantages. In some examples, the described techniques may lead to increased throughput (e.g., using the SBFD mode), reduced latency (e.g., the UE may be able to transmit the uplink and/or the downlink communications sooner in the SBFD mode), and increased network resource utilization (e.g., by using both downlink frequency resources and uplink frequency resources simultaneously instead of only the downlink frequency resources or the uplink frequency resources).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

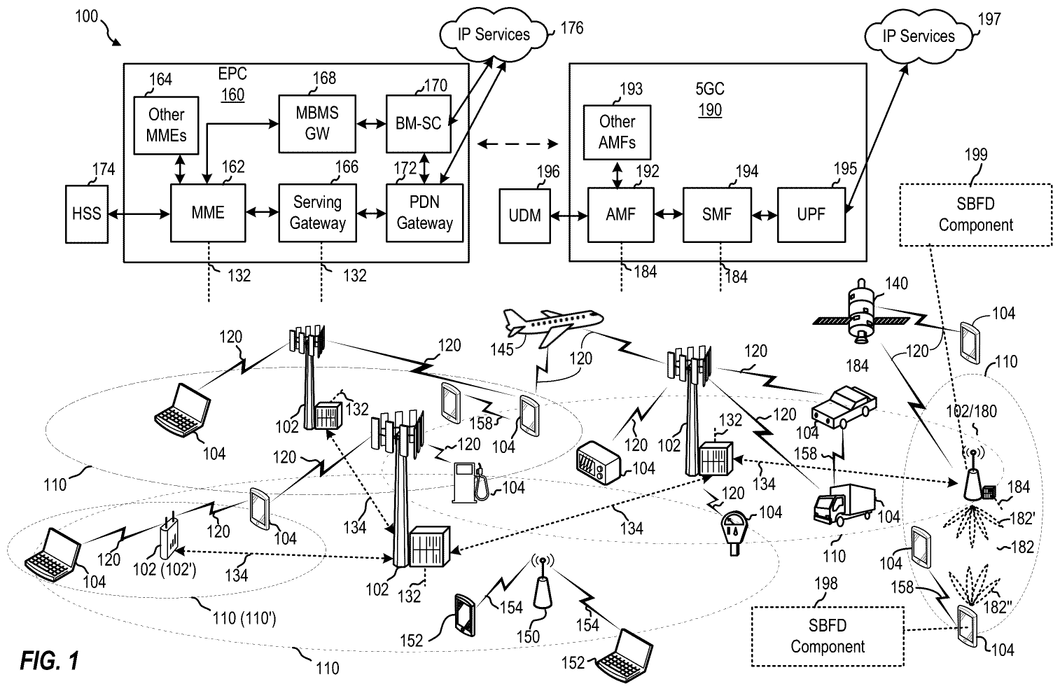

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

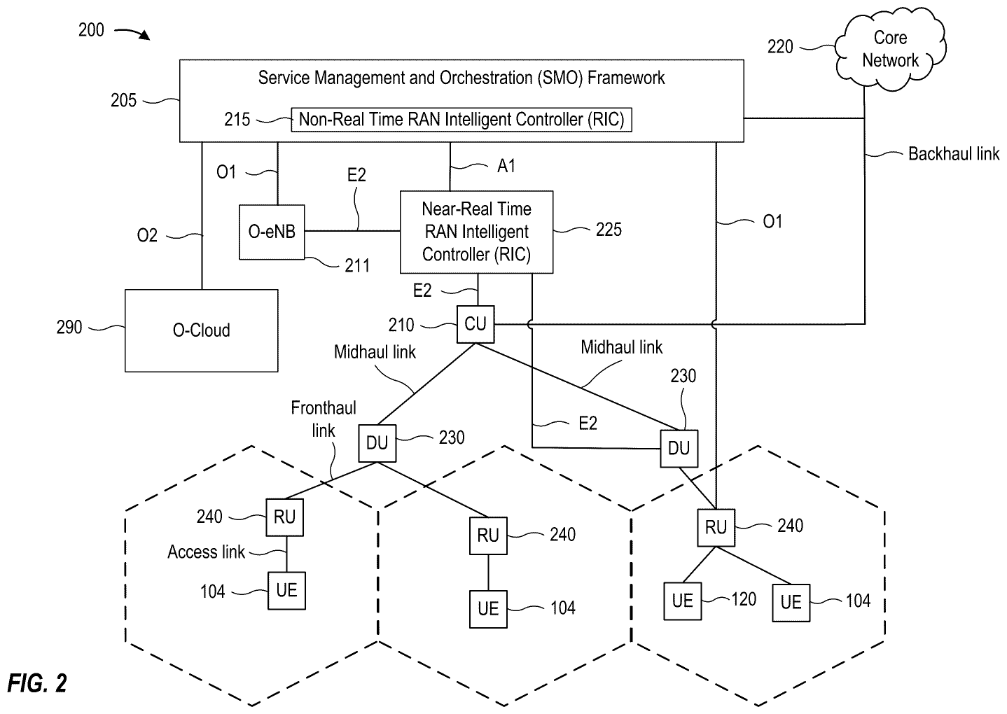

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHZ, which is sometimes referred to (interchangeably) as a “millimeter wave” (“mmW” or “mm Wave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

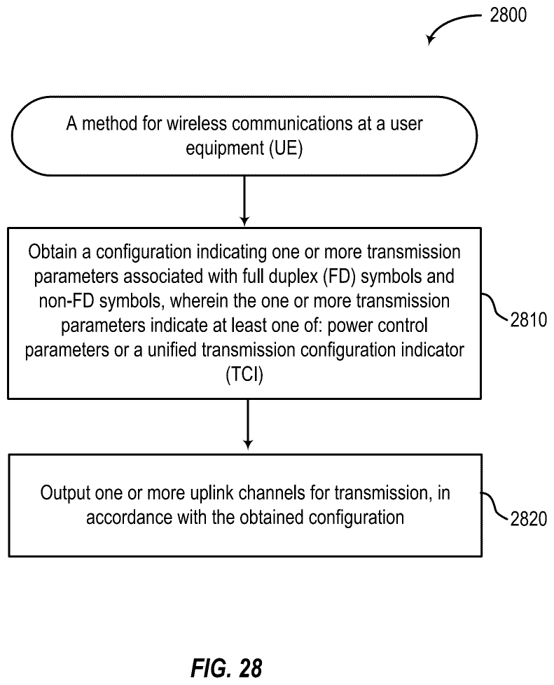

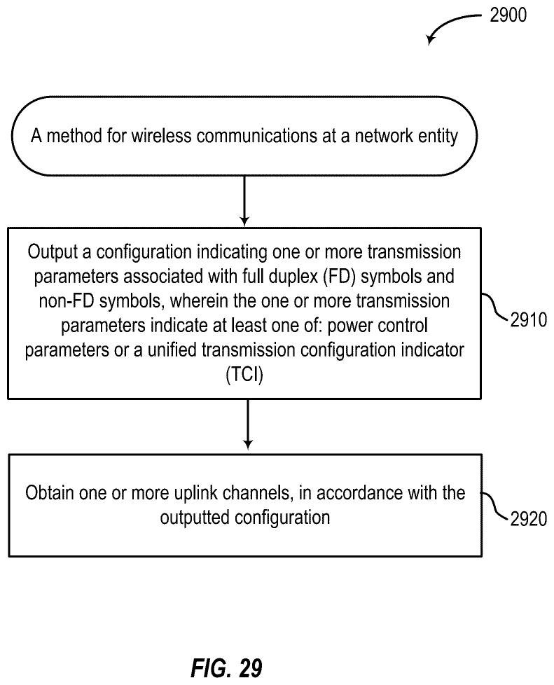

Wireless communication network 100 further includes sub-band full duplex (SBFD) component 198, which may be configured to perform method 2800 of FIG. 28. Wireless communication network 100 further includes SBFD component 199, which may be configured to perform method 2900 of FIG. 29.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

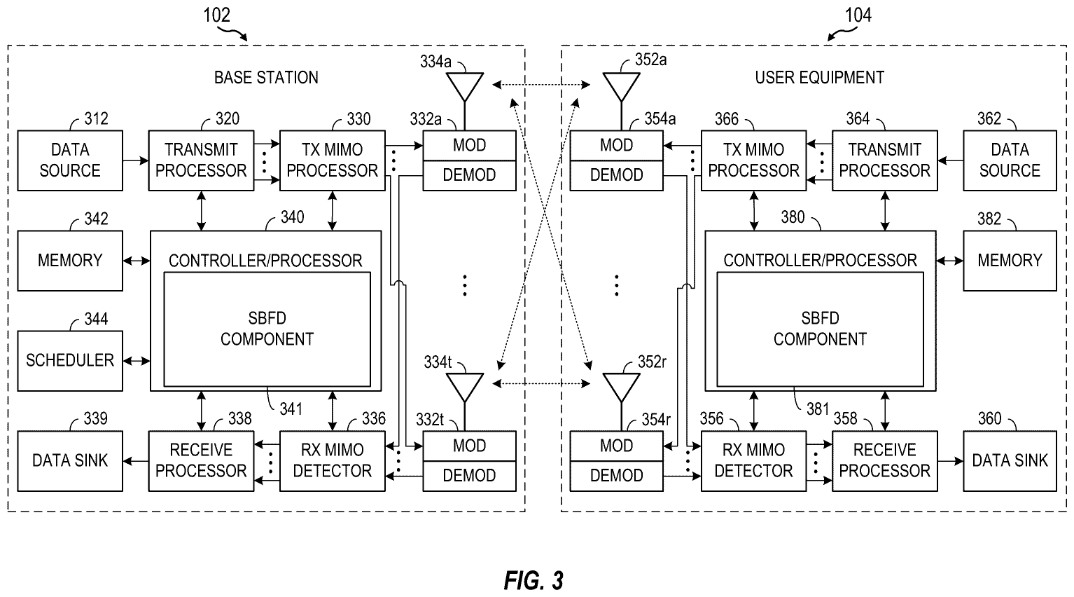

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., retrieved from data source 312) and wireless reception of data (e.g., provided to data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SBFD component 341, which may be representative of SBFD component 199 of FIG. 1. Notably, while depicted as an aspect of controller/processor 340, SBFD component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SBFD component 381, which may be representative of SBFD component 198 of FIG. 1. Notably, while depicted as an aspect of controller/processor 380, SBFD component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regard to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

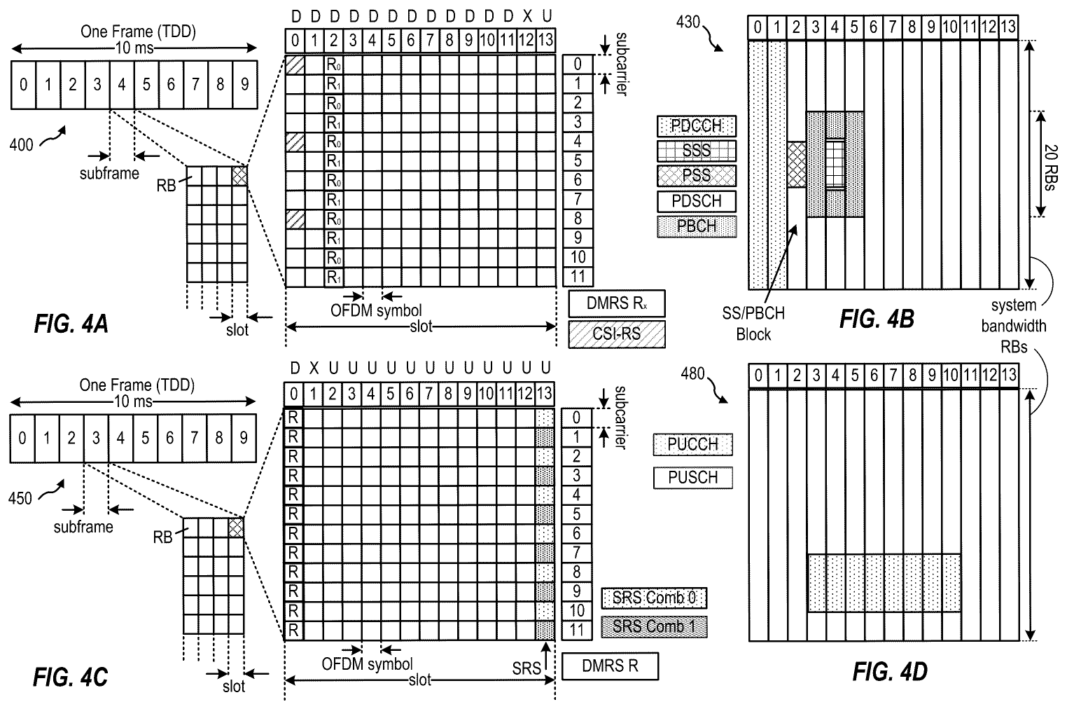

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Transmission Modes

Full-duplex (FD) allows for simultaneous transmission between nodes (e.g., a user equipment (UE) and a base station (BS)). In a half-duplex (HD) system, communication flows in one direction at a time.

There are various motivations for utilizing FD communications, for example, for simultaneous uplink (UL)/downlink (DL) transmissions in Frequency Range 2 (FR2). In some cases, FD capability may enable flexible time division duplexing (TDD) capability, and may be present at either a base station (BS) or a UE or both. For example, at the UE, UL transmissions may be sent from one antenna panel (e.g., of multiple antenna panels) and DL receptions may be performed at another antenna panel.

The FD capability may be conditional on a beam separation (e.g., self-interference between DL and UL, clutter echo, etc.). The FD capability may mean that the UE or the gNB is able to use frequency division multiplexing (FDM) or spatial division multiplexing (SDM) on slots conventionally reserved for UL only or DL only slots (or flexible slots that may be dynamically indicated as either UL or DL).

The potential benefits of the FD communications include latency reduction (e.g., it may be possible to receive DL signals in what would be considered UL only slots, which can enable latency savings), coverage enhancement, spectrum efficiency enhancements (per cell and/or per UE), and/or overall more efficient resource utilization.

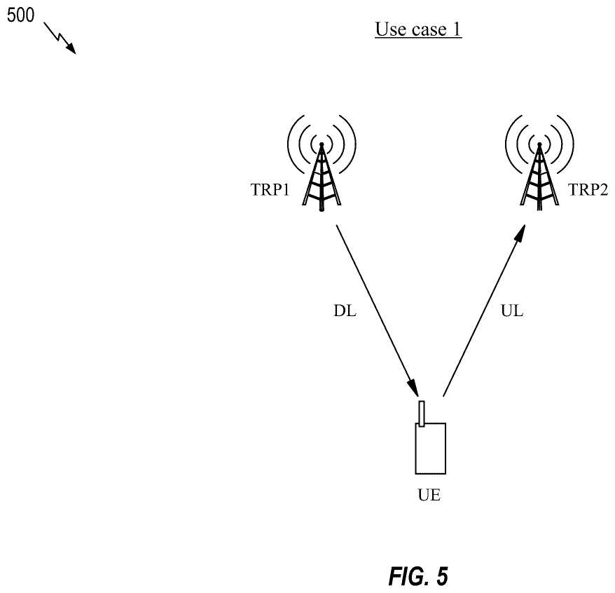

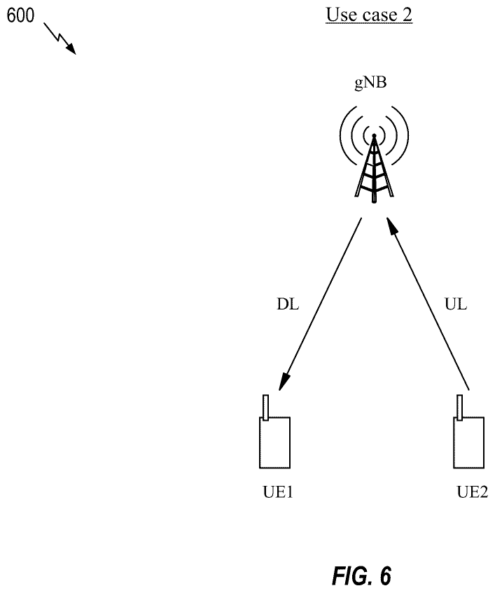

FIG. 5, FIG. 6, and FIG. 7 illustrate example use cases for FD communications. FIG. 8 summarizes certain possible features of these use cases.

Diagram 500 of FIG. 5 illustrates a first use case (e.g., Use Case 1) for FD communications. As illustrated, one UE simultaneously communicates with a first transmitter receive point (TRP 1) on DL, while transmitting to a second TRP on UL. For this use case, FD is disabled at a gNB (i.e., TRP 1, TRP 2) and enabled at the UE.

Diagram 600 of FIG. 6 illustrates a second use case (e.g., Use Case 2) for FD communications. As illustrated, one gNB simultaneously communicates with a first UE (UE 1) on DL, while communicating with a second UE (UE 2) on UL. For this use case, FD is enabled at the gNB and disabled at the UEs. Use cases with the FD enabled at the gNB and disabled at the UEs may be suitable for integrated access and backhaul (IAB) applications as well (e.g., as illustrated in a table 800 of FIG. 8).

Diagram 700 of FIG. 7 illustrates a third use case (e.g., Use Case 3) for FD communications. As illustrated, a UE simultaneously communicates with a gNB, transmitting on UL while receiving on DL. For this use case, FD is enabled at both the gNB and the UE.

Diagram 800 of FIG. 8 illustrates that the FD is disabled at the gNB and enabled at the UE for the first use case, the FD is enabled at the gNB and disabled at the UE for the second use case, and the FD is enabled at the gNB and enabled at the UE for the third use case.

### Overview of Sub-Band Full Duplex (SBFD)

As compared to older communication standards, spectrum options for 5G new radio (NR) are considerably expanded. For example, a frequency range 2 (FR2) band extends from approximately 24 GHz to 60 GHz. Since the wavelength decreases as the frequency increases, the FR2 band is denoted as a millimeter wave band due to its relatively-small wavelengths. In light of this relatively short wavelength, the transmitted radio frequency (RF) signals in the FR2 band behave somewhat like visible light. Thus, just like light, millimeter-wave signals are readily shadowed by buildings and other obstacles. In addition, the received power per unit area of antenna element goes down as the frequency goes up. For example, a patch antenna element is typically a fraction of the operating wavelength (e.g., one-half of the wavelength) in width and length. As the wavelength goes down (and thus the size of the antenna element decreases), it may thus be seen that the signal energy received at the corresponding antenna element decreases. Millimeter-wave cellular networks will generally require a relatively-large number of base stations (BSs) due to the issues of shadowing and decreased received signal strength. A cellular provider must typically rent the real estate for the BSs such that widespread coverage for a millimeter-wave cellular network may become very costly.

As compared to the challenges of FR2, the electromagnetic properties of radio wave propagation in the sub-6 GHz bands are more accommodating. For example, the 5G NR frequency range 1 (FR1) band extends from approximately 0.4 GHz to 7 GHZ. At these lower frequencies, the transmitted RF signals tend to refract around obstacles such as buildings so that the issues of shadowing are reduced. In addition, the larger size for each antenna element means that a FR1 antenna element intercepts more signal energy as compared to an FR2 antenna element. Thus, just as was established for older networks, a 5G NR cellular network operating in the FR1 band will not require an inordinate amount of BSs. Given the favorable properties of the lower frequency bands, the sub-6 GHz bands are often denoted as “beachfront” bands due to their desirability.

One issue with operation in the sub-6 GHz bands is that there is only so much bandwidth available. For this reason, Federal Communications Commission regulates the airwaves and conducts auctions for the limited bandwidth in the FR1 band. Given this limited bandwidth, it is challenging for a cellular provider to enable the high data rates that would be more readily achieved in the FR2 band. To meet these challenges, a “sub-band full duplex” (SBFD) network architecture is implemented, which is quite advantageous as it offers users the high data rates that would otherwise require usage of the FR2 band. The SBFD network architecture described herein provides the high data rates in the FR1 band, and thus lowers costs due to the smaller number of BSs per given area of coverage that may be achieved in the FR1 band as compared to the FR2 band.

Typically, each one millisecond (ms) sub frame may consist of one or multiple adjacent slots. For example, one sub frame includes four slots. In a four-slot structure, first two slots may be downlink (DL) slots whereas a final one of the four slots is an uplink (UL) slot. The third slot is a special slot in which some symbols may be used for UL transmissions and others for DL transmissions. The resulting UL and DL traffic is thus time division duplexed (TDD) as arranged by the dedicated slots and as arranged by the symbol assignment in the special slot. Since the UL has only a single dedicated slot, UL communication may suffer from excessive latency since a user equipment (UE) is restricted to transmitting in the single dedicated UL slot and in the resource allocations within the special slot. Since there is only one dedicated UL slot in the repeating four-slot structure, the resulting latency can be problematic particularly for low-latency applications such as vehicle-to-vehicle communication. In addition, the energy for the UL communication is limited by its single dedicated slot.

To reduce uplink latency and increase the energy for the UL transmissions, SBFD mode may be implemented. The SBFD mode is a duplex mode with a TDD carrier split into sub-bands to enable simultaneous transmission and reception in same slots. For example, in the SBFD mode, some slots are modified as SBFD slots to support frequency duplexing for simultaneous UL and DL transmissions. Some slots may remain as legacy TDD slots where one slot is still dedicated to DL and another slot dedicated to UL. In one example four-slot structure, in the SBFD mode, the second and third slots may be SBFD slots modified to support frequency duplexing for simultaneous UL and DL transmissions. The first slot and the fourth slot may remain as legacy TDD slots such that the first slot is still dedicated to DL and the fourth slot dedicated to UL. In other examples, any slot may be used in the SBFD mode.

In the sub-6 GHz spectrum, the relatively-limited separation between antennas on a device will lead to substantial self-interference should the device engage in a simultaneous UL and DL transmission. In some cases, the frequency duplexing in the SBFD slots may be practiced by a BS transceiver.

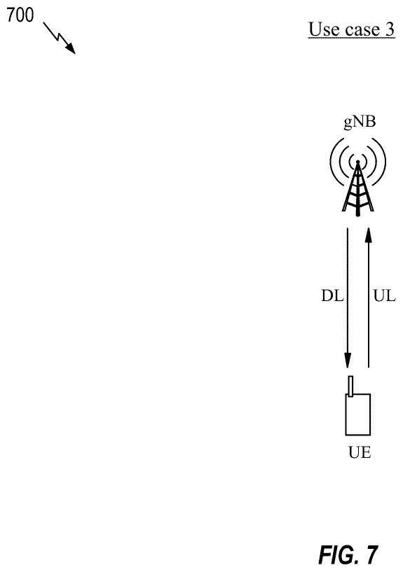

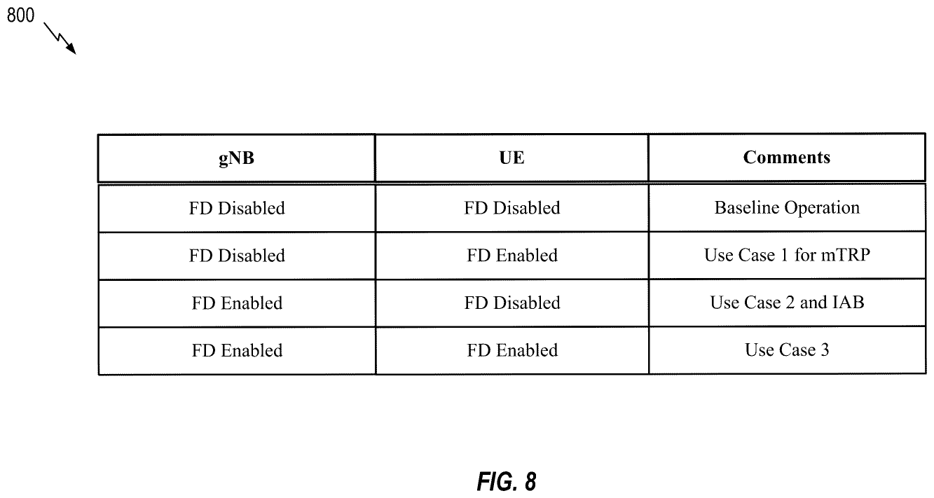

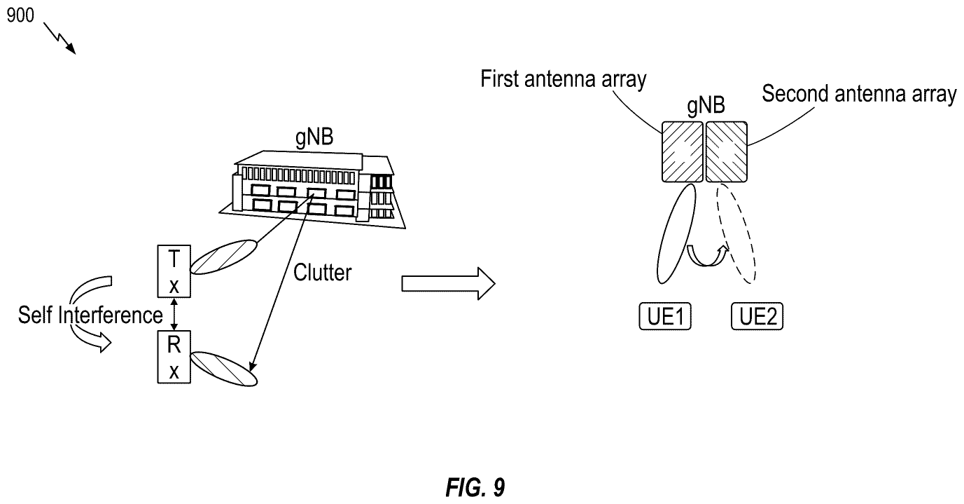

For example, diagram 900 of FIG. 9 depicts full-duplex (FD) operation at a gNodeB (gNB). An antenna system for the gNB is subdivided into a first antenna array that is separated from a second antenna array by an insulating distance such as, for example, 10 to 30 cm. During the SBFD operation, one of the antenna arrays transmits (e.g., to a first UE (UE1)) while the other antenna array is receiving (e.g., from a second UE (UE2)). The self-interference problem is partially addressed by a physical separation between the antenna arrays of the gNB. To provide additional isolation, a conducting shield between the antenna arrays of the gNB may also be implemented. It will be appreciated, however, that frequency duplexing may also be practiced by a device (or more generally, the first UE or the second UE) should the device practice sufficient self-interference cancellation. In other cases, however, the first UE or the second UE may be limited to half-duplex (HD) transmission such that an antenna array of the first UE or the second UE is entirely dedicated to just transmitting or to just receiving in respective slots.

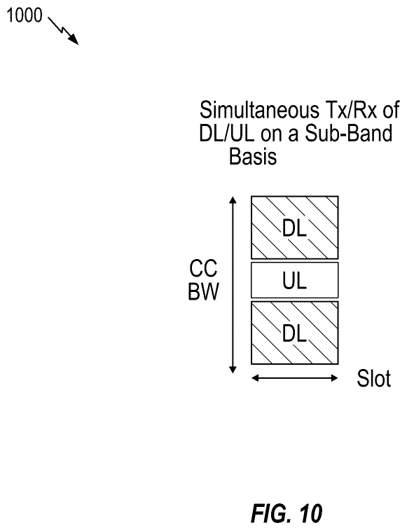

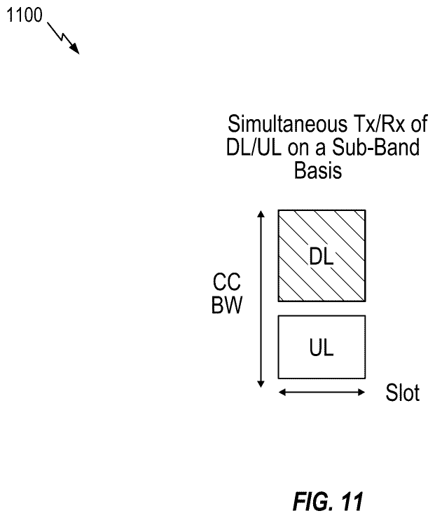

Example SBFD slots are depicted in FIG. 10 and FIG. 11. For example, FIG. 10 depicts SBFD slot 1000 and FIG. 11 depicts SBFD slot 1100. Note that neither the UL nor the DL in the SBFD slots 1000, 1100 may occupy an entire frequency resource range (e.g., a frequency band) for these SBFD slots.

As depicted in FIG. 10, the UL occupies a central sub-band in the frequency band for the SBFD slot 1000. The DL occupies a lower sub-band that ranges from a lower frequency for the frequency band up to a lowest frequency for the UL central sub-band. In some cases, the sub-bands may be separated by a guard band. The DL also occupies an upper sub-band in the frequency band and extends from a greatest frequency for the UL central sub-band to a greatest frequency for the frequency band. In one example, the UL central sub-band may be symmetric about a center frequency for the SBFD slot 1000. In such example, the bandwidth for the DL lower sub-band and the DL upper sub-band would be equal. However, in other examples, the DL lower sub-band bandwidth may be different from the bandwidth for the DL upper sub-band. In some examples, the DL upper and lower sub-bands may each have the bandwidth that may vary as 10 MHZ, 20 MHZ, 30 MHz or 40 MHz depending upon a DL data rate.

The use of the SBFD slot is advantageous with regard to minimizing or reducing UE-to-UE interference and transmit-to-receive self-interference at a BS. In some cases, the use of the SBFD slot may also enhance system capacity, improve resource utilization and spectrum efficiency (e.g., by enabling flexible and dynamic UL/DL resource adaption according to UL/DL traffic in a robust manner).

### Overview of Transmission Configuration Indicator (TCI) States

A transmission configuration indicator (TCI) state may be used to indicate a Quasi Co-Location (QCL) relationship between one or more downlink reference signals (DL RSs) and DMRS antenna port(s) for a physical downlink control channel (PDCCH) and a physical downlink shared channel (PDSCH). Two antenna ports are considered to be Quasi Co-Located (QCL'ed) when the properties of a channel over which a symbol on one antenna port is conveyed can be inferred from the channel over which a symbol on the other antenna port is conveyed.

Four types of QCL have been defined in the 5G new radio (NR) standards and are designated as Types A through D. The QCL types are defined as QCL-TypeA, which includes Doppler shift, Doppler spread, average delay, delay spread; QCL-TypeB including Doppler shift and Doppler spread; QCL-TypeC including Doppler shift and average delay; and QCL-TypeD including a spatial receiver (Rx) parameter. When two DL RSs are included in a TCI state, the QCL types will always be different no matter whether the two DL RSs are the same DL RS or are different DL RSs. In some cases, the DL RSs could be a synchronization signal block (SSB) including a synchronization signal SS (e.g., a primary synchronization signal (PSS) and/or a secondary synchronization signal (SSS)) and a physical broadcast channel (PBCH), or a channel-state information reference signal (CSI-RS). Additionally, with certain QCL types, two signal ports are considered to be QCL'ed when the channels share the same property indicated by the QCL type.

When a TCI state is determined for a PDSCH DMRS, it is noted that a user equipment (UE) may be configured with a set of the possible TCI states that are communicated to the UE in a radio resource control (RRC) level message (e.g., a PDSCH-Config message). For example, the RRC level message may be configured with a TCI state that serves to associate one or more DL RSs with a corresponding QCL type. In particular, the UE will receive a medium access control (MAC)-control element (CE) command to down select a subset of TCI states configured in the RRC message. Additionally, in some cases, the UE may receive downlink control information (DCI) to further select a particular single TCI state from the subset of TCI states.

A NR system may support carrier aggregation using multiple component carrier (CCs). In some cases, one or more CCs may be divided into bandwidth parts (BWPs) and one BWP may be active for communications using a CC. In one example, a communication link may support transmissions using multiple CCs (e.g., up to 16 uplink CCs and up to 16 downlink CCs). In some cases, one MAC-CE may be used to configure two or more CCs with two or more different sets of active TCI states.

In some cases, each CC may be uniquely identified and configured for physical channel and reference signal transmissions. For example, a beam selection may be indicated to a UE via a MAC-CE for each downlink and uplink CC. The configuration of each CC may lead to increased signaling overhead in the wireless system.

In some cases, when the UE is configured with multiple CCs, a relatively large number of MAC-CEs (e.g., up to 16 MAC-CEs, one for each of the up to 16 CCs) may be used to select different TCI state identifiers (ID) in every CC (e.g., in downlink NR-NR carrier aggregation). The use of this number of MAC-CEs may lead to an increase in signaling overhead between the UE and a base station (BS). In order to reduce the number of MAC-CEs used for conveying the active sets of TCI states in each CC configured for communications between the network entity and the UE, a single MAC-CE command may be used to activate two or more different sets of active TCI states for a number of CCs/BWPs for which the TCI states are active (e.g., for multiple CCs/BWPs) and may then indicate the activated TCI states to the UE. For example, a first set of activated TCI states may be selected to be associated with a first group of one or more CCs, and a second set of activated TCI states may be selected to be associated with a second group of one or more CCs.

In some cases, the single MAC-CE may be used to activate different sets of active TCI states for data communications (e.g., a PDSCH or a physical uplink shared channel (PUSCH)) in groups of different CCs within a preconfigured CC list. This is in contrast to the use of the multiple MAC-CEs, where each MAC-CE is used to select the sets of active TCI states in the active BWP of a corresponding individual CC (e.g., in downlink NR-NR carrier aggregation), which may result in the increased signaling overhead between the UE and the network entity.

For example, a BS may send a MAC-CE indicating TCI state activation to a first CC of a preconfigured CC list, and the TCI state activation is applicable to all other CCs of the preconfigured CC list. That is, the MAC-CE TCI activation to the first CC is applicable to all the other CCs in the preconfigured CC list including the first CC. In some cases, not only the MAC-CE TCI state activation, but DCI indication for a unified TCI state activation is also applicable to all the other CCs in the preconfigured CC list.

In some cases, a unified TCI state activation framework (e.g., based on the single MAC-CE or the DCI to activate the different active TCI states for the different CCs) may be applicable for a single transmission receive point (TRP) mode case where each CC within the preconfigured CC list is associated with a single TRP.

### Overview of Unified Transmission Configuration Indicator (TCI) State Activation/Deactivation Medium Access Control (MAC)-Control Element (CE)

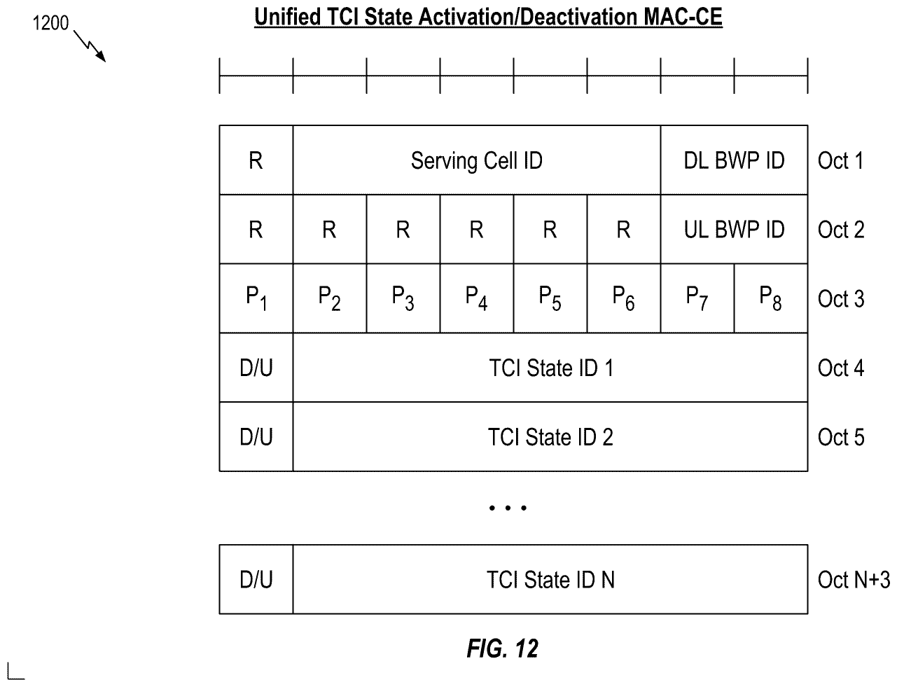

A unified transmission configuration indicator (TCI) state activation/deactivation medium access control—control element (MAC-CE) may be identified by a MAC sub header with an extended logical channel identification (eLCID), as specified in a diagram 1200 of FIG. 12. As shown in FIG. 12, the MAC-CE may have a variable size consisting of fields such as a serving cell ID field, a downlink (DL) bandwidth part (BWP) ID field, an uplink (UL) BWP ID field, a Pᵢ field, a D/U field, a TCI state ID field, and a reserved bit (R) field.

The serving cell ID field may indicate an identity of a serving cell for which the MAC-CE applies. The length of the serving cell ID field is 5 bits. If the indicated serving cell is configured as part of a simultaneousU-TCI-UpdateList1, simultaneousU-TCI-UpdateList2, simultaneousU-TCI-UpdateList3 or simultaneousU-TCI-UpdateList4, the MAC-CE applies to all serving cells in the set simultaneousU-TCI-UpdateList1, simultaneousU-TCI-UpdateList2, simultaneousU-TCI-UpdateList3 or simultaneousU-TCI-UpdateList4, respectively.

The DL BWP ID field may indicate a DL BWP for which the MAC-CE applies as a code point of the DCI BWP indicator field. The length of the DL BWP ID field is 2 bits. The code point may refer to a specific value in a field (e.g., such as the DCI BWP indicator field).

The UL BWP ID field may indicate an UL BWP for which the MAC-CE applies as a code point of the DCI BWP indicator field. If a value of unifiedTCI-State Type in the serving cell indicated by the serving cell ID is joint, the UL BWP ID field is considered as reserved bits. The length of the UL BWP ID field is 2 bits. A parameter such as the unifiedTCI-StateType may indicate a unified TCI state type configured for a device (e.g., a user equipment (UE)) for a serving cell.

The Pᵢ field may indicate whether each TCI code point may have multiple TCI states or a single TCI state. If Pᵢ field is set to 1, it indicates that i^{th} TCI code point includes a DL TCI state and an UL TCI state. If Pᵢ field is set to 0, it indicates that i^{th} TCI code point includes only the DL/joint TCI state or the UL TCI state. The code point to which a TCI state is mapped is determined by its ordinal position among all TCI state ID fields.

The D/U field may indicate whether a TCI state ID in a same octet is for joint/DL or UL TCI state. If the D/U field is set to 1, the TCI state ID in the same octet is for joint/DL. If the D/U field is set to 0, the TCI state ID in the same octet is for UL.

The TCI state ID field may indicate a TCI state identified by TCI-StateId. If D/U is set to 1, 7-bits length TCI state ID, i.e., TCI-StateId is used. If D/U is set to 0, a most significant bit of the TCI state ID is considered as a reserved bit and remainder 6 bits indicate a TCI-UL-State-Id. The maximum number of activated TCI states is 16. The reserved bit (R) field may be set to 0.

### Overview of Unified Transmission Configuration Indicator (TCI) Framework

A radio resource control (RRC) configuration (e.g., per cell) may indicate whether a unified transmission configuration indicator (TCI) is a joint downlink (DL)/uplink (UL) TCI state or separate UL/DL TCI states. A unified medium access control (MAC)-control element (CE) may activate unified TCI states and may indicate whether a TCI code point has two TCI sates (i.e., separate UL/DL TCI states) or a single TCI state (i.e., a joint UL/DL TCI state or UL-only TCI state or DL-only TCI state). A DL TCI format 1_1/1_2 may have TCI states that may indicate a TCI code point, either UL-only TCI state, a DL-only TCI state or a joint UL/DL TCI state or separate UL/DL TCI states. The TCI code point may refer to a specific value in a TCI field.

Aspects Related to Enhancement for s-TRP Separate Uplink Power Control and Unified TCI States for SBFD and Non-SBFD Symbols

Aspects of the present disclosure provide apparatuses, methods, processing systems, and computer-readable mediums for managing uplink transmissions on different symbols/slots such as sub-band full duplex (SBFD) symbols/slots and non-SBFD symbols/slots.

SBFD refers to a mode where a time division duplex (TDD) carrier is split into sub-bands to enable simultaneous transmission and reception (e.g., on different sub-bands) in a same slot (e.g., that consists of multiple symbols) or in a same symbol. For example, in an SBFD mode, a user equipment (UE) may transmit an uplink communication to a gNodeB (gNB) and receive a downlink communication from the gNB at a same time, but on different frequency resources. The different frequency resources may be the sub-bands of a frequency band. The frequency resources used for the downlink communication may be separated from the frequency resources used for the uplink communication, in a frequency domain, by a guard band.

To enable the UE to transmit the uplink transmissions on the SBFD symbols/slots and the non-SBFD symbols/slots, techniques described herein provide transmission parameters to be applied for the uplink transmissions on the SBFD symbols/slots and the non-SBFD symbols/slots. For example, the gNB may configure and indicate to the UE separate uplink power control parameters applicable for the uplink transmissions on the SBFD symbols/slots and the non-SBFD symbols/slots. In another example, the gNB may configure and indicate to the UE separate unified transmission configuration indicator (TCI) states applicable for the uplink transmissions on the SBFD symbols/slots and the non-SBFD symbols/slots (e.g., to implicitly enable different beams, different uplink power control parameters in the SBFD symbols/slots and the non-SBFD symbols/slots).

Particular aspects of the subject matter described in this disclosure can be implemented to realize one or more of the following potential advantages. In some examples, the described techniques may lead to increased throughput (e.g., using the SBFD mode), reduced latency (e.g., the UE may be able to transmit the uplink and/or the downlink communications sooner in the SBFD mode), and increased network resource utilization (e.g., by using both downlink frequency resources and uplink frequency resources simultaneously instead of only the downlink frequency resources or the uplink frequency resources).

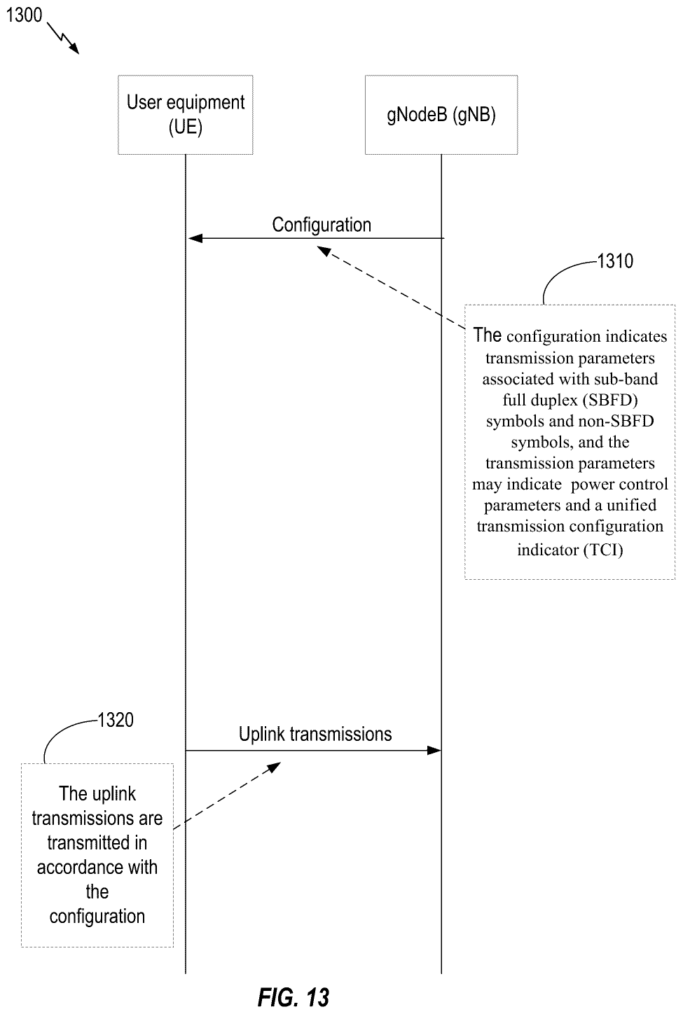

The techniques proposed herein for managing the uplink transmissions on the SBFD symbols/slots and the non-SBFD symbols/slots may be understood with reference to FIG. 13-FIG. 31.

FIG. 13 depicts a call flow diagram 1300 illustrating example communication among wireless nodes such as a UE and a network entity (e.g., a gNB) for managing transmissions on symbols/slots associated with SBFD communications and non-SBFD communications.

The UE shown in FIG. 13 may be an example of the UE 104 depicted and described with respect to FIG. 1 and FIG. 3. The gNB depicted in FIG. 13 may be an example of the BS 102 depicted and described with respect to FIG. 1 and FIG. 3, or the disaggregated BS depicted and described with respect to FIG. 2.

As indicated at 1310, the gNB sends a configuration to the UE. The UE receives the configuration from the gNB. The configuration indicates transmission parameters (e.g., for the uplink transmissions). The transmission parameters may be associated with SBFD symbols (and/or SBFD slots). The transmission parameters may also be associated with non-SBFD symbols (and/or non-SBFD slots).

The SBFD symbols/slots may refer to symbols/slots in which an SBFD format is used. In one example, the SBFD format may include a symbol/slot format in which full duplex communication is supported (e.g., for both uplink and downlink communications), with one or more frequencies used for an uplink portion of the symbol/slot being separated from one or more frequencies used for a downlink portion of the symbol/slot by a guard band.

In another example, the SBFD format may include a single uplink portion of the symbol/slot and a single downlink portion of the symbol/slot separated by a guard band.

In another example, the SBFD format may include multiple downlink portions of the symbol/slot and a single uplink portion of the symbol/slot that is separated from the multiple downlink portions by respective guard bands.

In another example, the SBFD format may include multiple uplink portions of the symbol/slot and a single downlink portion of the symbol/slot that is separated from the multiple uplink portions by respective guard bands.

In another example, the SBFD format may include multiple uplink portions of the symbol/slot and multiple downlink portions of the symbol/slot, where each uplink portion of the symbol/slot is separated from a downlink portion of the symbol/slot by a guard band.

In certain aspects, the transmission parameters may indicate power control parameters (e.g., such as uplink power control parameters). The uplink power control parameters may be used to determine power for the uplink transmissions such as a physical uplink shared channel (PUSCH) transmission, a physical uplink control channel (PUCCH) transmission, a sounding reference signal (SRS) transmission, etc.

In one example, the power control parameters may include a received power target value associated with the SBFD symbols/slots and/or the non-SBFD symbols/slots. In another example, the power control parameters may include a power control factor value associated with the SBFD symbols/slots and/or the non-SBFD symbols/slots. In another example, the power control parameters may include a closed-loop power control value associated with the SBFD symbols/slots and/or the non-SBFD symbols/slots.

For example, an uplink power (Pₜₓ) for the uplink transmissions (e.g., based on the power control parameters such as P_{CMAX}, P₀, alpha (α)) has a formula of:

$${P}_{tx} = min \{ {P}_{CMAX} , {P}_{0} + α \cdot PL + Δ \}$$

where P_{CMAX} is a UE configured maximum output power; P₀ is a pre-configured received power target assuming full path loss compensation; α between 0 and 1 is a fractional power control factor (e.g., α=0 means no path loss compensation, i.e. all UEs transmit at the same power; and α=1 means full path loss compensation, which tries to achieve same received power for all UEs); Δ is a closed loop power control component, which allows the gNB to adjust the transmit power at the UE. A may be based on a transmit power control (TPC) command from downlink control information (DCI) on a physical downlink control channel (PDCCH). In certain aspects, the transmission parameters may indicate a unified TCI (state) per unified TCI framework. In one example, the unified TCI may indicate a joint uplink and downlink TCI state associated with the SBFD symbols/slots and/or the non-SBFD symbols/slots. In another example, the unified TCI may indicate separate uplink and downlink TCI states associated with the SBFD symbols/slots and/or the non-SBFD symbols/slots.

For example, per the unified TCI framework, a unified or master or main TCI state may be signaled or indicated to the UE. The unified or master or main TCI state may be one of: (1) in case of joint TCI state indication, wherein a same beam is used for downlink and uplink channels, a joint TCI state that can be used at least for UE-dedicated downlink channels and UE-dedicated uplink channels; (2) in case of separate TCI state indication, wherein different beams are used for downlink and uplink channels, a downlink TCI state that can be used at least for UE-dedicated downlink channels; and/or (3) in case of separate TCI state indication, wherein different beams are used for downlink and uplink channels, an uplink TCI state that can be used at least for UE-dedicated uplink channels.

As indicated at 1320, the UE transmits the uplink transmissions to the gNB, in accordance with the received transmission parameters. For example, the UE may transmit the uplink transmissions via the SBFD symbols/slots and/or via the non-SBFD symbols/slots based on the power determined using the power control parameters. In another example, the UE may transmit the uplink transmissions via the SBFD symbols/slots and/or via the non-SBFD symbols/slots based on information associated with the unified TCI.

In certain aspects, the transmission parameters may further indicate different sets of the power control parameters associated with (e.g., may be each of) the SBFD symbols/slots and the non-SBFD symbols/slots. In such cases, the UE may send the uplink transmissions to the gNB via the SBFD symbols/slots and via the non-SBFD symbols/slots in accordance with the different sets of the power control parameters associated with the SBFD symbols/slots and the non-SBFD symbols/slots.

For example, each TCI state may be configured with up to two sets of power control parameters and each power control parameter set may be associated with a specific duplex type (e.g., an SBFD symbol/slot, a non-SBFD symbol/slot). The TCI state may be either a joint downlink/uplink TCI state or an uplink-only TCI state. The power control parameters may refer to P₀, alpha and closed-loop power index. Additionally, the TCI state may be configured with different path loss (PL) reference signal (RS) for the SBFD symbols/slots and the non-SBFD symbols/slots. The UE may use any additional power control parameters for the uplink transmissions in the SBFD symbols/slots (if provided/configured). Otherwise, by default, the UE may utilize a first set of power control parameters for the uplink transmissions in both the SBFD symbols/slots and the non-SBFD symbols/slots.

With separate power control parameters for the SBFD symbols/slots and the non-SBFD symbols/slots, the gNB may configure a same uplink beam for the SBFD symbols/slots and the non-SBFD symbols/slots. In addition, the gNB may configure separate uplink beams for the SBFD symbols/slots and the non-SBFD symbols/slots, as and when separate uplink unified TCI states are configured for the SBFD symbols/slots and the non-SBFD symbols/slots. By default, with the gNB configuration, the UE may apply same uplink beams for the uplink transmissions on the SBFD symbols/slots and the non-SBFD symbols/slots.

In certain aspects, the transmission parameters may further indicate a single set of the power control parameters (e.g., associated with the SBFD symbols/slots and/or the non-SBFD symbols/slots) and a power control offset value. Such transmission parameters may be used for a case of same uplink beams and where transmit beams are not same but sufficiently close. The gNB may configure the power control offset value using a radio resource control (RRC) signaling. The power control offset value may indicate a difference between a first transmission power value associated with the SBFD symbols/slots and a second transmission power value associated with the non-SBFD symbols/slots. That is, a transmission power may be different by an offset between the SBFD symbols/slots and the non-SBFD symbols/slots and the single set of the power control parameters can be used as the transmission parameters.

In one example, the UE may send the uplink transmissions to the gNB via the SBFD symbols/slots based on power determined using the single set of the power control parameters and via the non-SBFD symbols/slots based on power determined using another set of the power control parameters (e.g., which may be based on the single set of the power control parameters and the power control offset value).

In another example, the UE may send the uplink transmissions to the gNB via the non-SBFD symbols/slots based on the power determined using the single set of the power control parameters and via the SBFD symbols/slots based on the power determined using the another set of the power control parameters (e.g., which may be based on the single set of the power control parameters and the power control offset value).

In certain aspects, the gNB may send to the UE a medium access control-control element (MAC-CE) indicating an adjustment of the power control offset value (i.e., a new power control offset value). In other aspects, the gNB may send to the UE a downlink control information (DCI) indicating the adjustment of the power control offset value. In such cases, the UE may send the uplink transmissions to the gNB via the SBFD symbols/slots based on the power determined using the single set of the power control parameters and via the non-SBFD symbols/slots based on the power determined using the single set of the power control parameters and the new power control offset value. In another example, the UE may send the uplink transmissions to the gNB via the non-SBFD symbols/slots based on the power determined using the single set of the power control parameters and via the SBFD symbols/slots based on the power determined using the single set of the power control parameters and the new power control offset value.

In certain aspects, the transmission parameters may further indicate a same downlink and uplink beam associated with the SBFD symbols/slots and the non-SBFD symbols/slots. In such cases, the UE may send the uplink transmissions to the gNB via the SBFD symbols/slots and via the non-SBFD symbols/slots by using the same downlink and uplink beam.

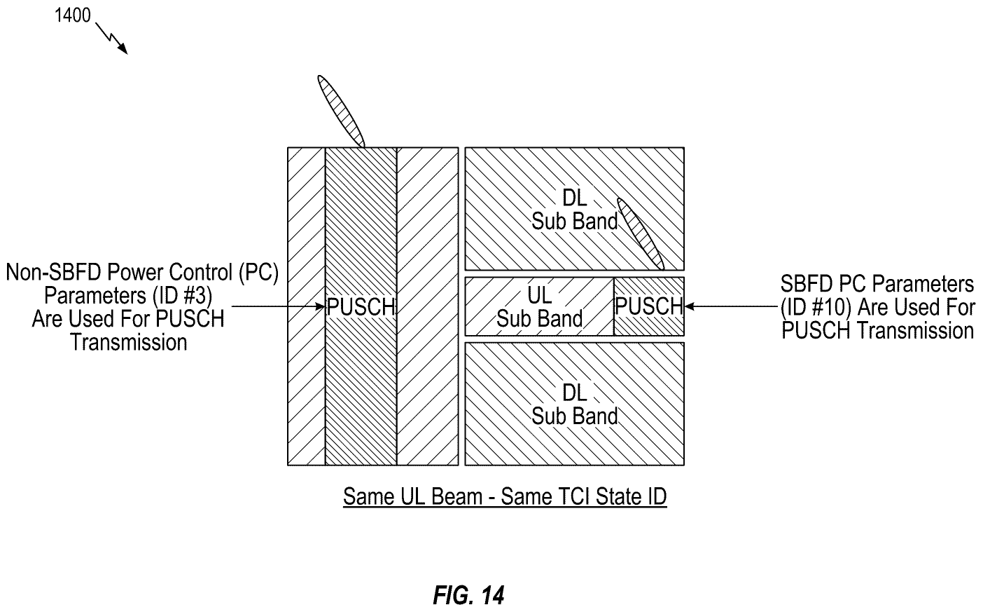

FIG. 14 depicts a diagram 1400 illustrating different power control parameters being used for different PUSCH transmissions associated with a same TCI state and a same beam (e.g., a same uplink beam). For example, non-SBFD power control parameters are used by the UE for one PUSCH transmission via the non-SBFD symbols/slots and SBFD power control parameters are used by the UE for another PUSCH transmission via the SBFD symbols/slots.

In certain aspects, the transmission parameters may further indicate separate downlink beams associated with the SBFD symbols/slots and the non-SBFD symbols/slots, and/or separate uplink beams associated with the SBFD symbols/slots and the non-SBFD symbols/slots. In such cases, the UE may send the uplink transmissions to the gNB via the SBFD symbols/slots and via the non-SBFD symbols/slots by using the separate uplink beams.

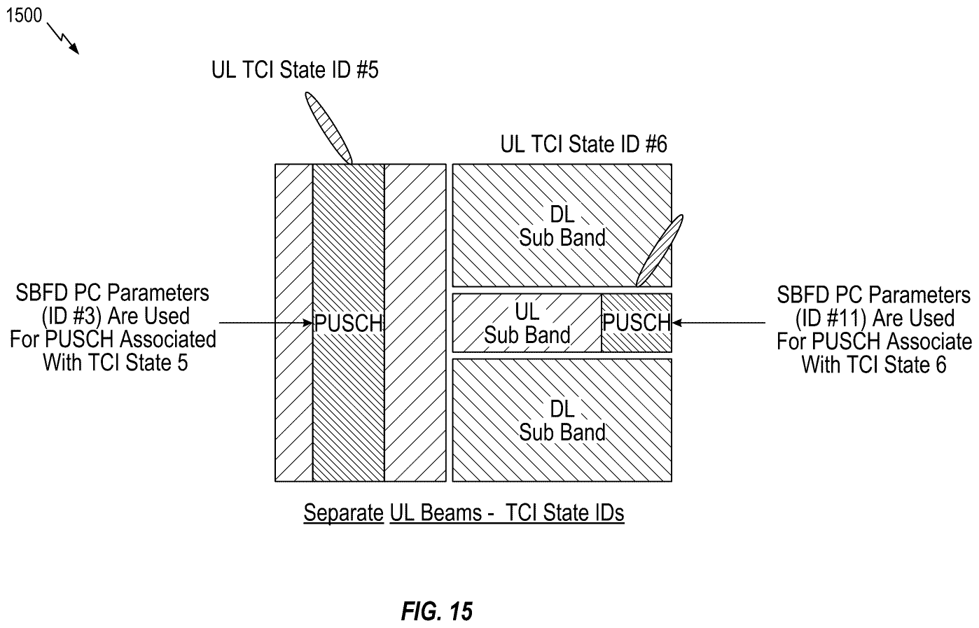

FIG. 15 depicts a diagram 1500 illustrating same power control parameters being used for different PUSCH transmissions associated with different TCI states and different beams (e.g., different uplink beams). For example, SBFD power control parameters are used by the UE for a PUSCH transmission (e.g., associated with a first TCI state such as a TCI state 5) via the SBFD symbols/slots and another PUSCH transmission (e.g., associated with a second TCI state such as a TCI state 6) via the SBFD symbols/slots.

In certain aspects, the transmission parameters may further indicate different TCI state types associated with the SBFD symbols/slots and the non-SBFD symbols/slots. In such cases, the UE may send the uplink transmissions to the gNB via the SBFD symbols/slots and via the non-SBFD symbols/slots associated with the different TCI state types.

Each of the different TCI state types may indicate separate uplink and downlink TCI states or a joint uplink and downlink TCI state (e.g., a unified TCI type (e.g., separate vs joint TCI state) may be configured separately per each duplex type (e.g., SBFD vs non-SBFD)). The separate uplink and downlink TCI states may indicate an uplink TCI state and a downlink TCI state.

The joint uplink and downlink TCI state and the downlink TCI state may be associated with different TCI pools.

The joint uplink and downlink TCI state and the downlink TCI state may be associated with a same TCI pool. For example, to save an RRC signaling overhead for configured TCI states for duplicated pools, a downlink TCI pool may serve for a joint TCI pool. The TCI pool may include a collection of TCIs or a set of TCIs (e.g., for a given bandwidth part).

In certain aspects, the transmission parameters may further indicate a same TCI state type (e.g., a same unified TCI may be configured across both duplex types (e.g., SBFD and non-SBFD)). The same TCI state type may indicate separate uplink and downlink TCI states. In such cases, the UE may send the uplink transmissions to the gNB via the SBFD symbols/slots and via the non-SBFD symbols/slots associated with the same TCI state type.

In some aspects, when the unified TCI is configured separately per each duplex type, TCI states for uplink/downlink may be separate for each duplex type.

The techniques proposed herein may support separate unified TCIs for uplink channels/RSs in SBFD and non-SBFD symbols in different slots, and may also support separate unified TCIs for downlink and/or uplink channels/RSs in the SBFD and non-SBFD symbols in the different slots for a single transmit receive point (sTRP) scenario.

In certain aspects, the gNB may send to the UE an RRC message indicating multiple TCI pools associated with multiple TCI states associated with the SBFD symbols/slots and the non-SBFD symbols/slots.

For example, an RRC signaling may be used to configure two TCI pools for the SBFD symbols/slots and the non-SBFD symbols/slots (e.g., a joint TCI pool for non-SBFD symbols/slots and separate TCI pools for SBFD symbols/slots) and also indicate with a new duplex type field. For example, a one bit (RRC) duplex type field may be indicate ‘SBFD’ or ‘non-SBFD’.

In certain aspects, when the multiple TCI pools are associated with a first component carrier (CC) of a set of CCs, then the multiple TCI pools are associated with all other CCs in the set of CCs. For example, in case of multiple CCs, two TCI pools may be configured under one bandwidth part (BWP)/CC and referred by other BWPs/CCs.

In certain aspects, the gNB may send to the UE different MAC-CEs to activate or indicate different TCI states associated with the SBFD symbols/slots and the non-SBFD symbols/slots. In one aspect, the gNB may use the different MAC-CEs to activate the different TCI states associated with the SBFD symbols/slots and the non-SBFD symbols/slots. In another aspect, the gNB may send the different MAC-CEs to indicate the different TCI states associated with the SBFD symbols/slots and the non-SBFD symbols/slots. In another aspect, the gNB may send the different MAC-CEs to indicate activated different TCI states associated with the SBFD symbols/slots and the non-SBFD symbols/slots. For example, when the RRC signaling may configure multiple uplink TCI states or a downlink/joint TCI state under the unified TCI framework, then the UE may receive two MAC-CEs (e.g., one MAC-CE per each duplex type) from the gNB. Each MAC-CE may activate one or more TCI code points (e.g., with up to two TCI states per code point) that may be applicable for the SBFD symbols/slots or the non-SBFD symbols/slots.

In one aspect, a value of a first reserved bit in each MAC-CE to the UE may indicate that the particular MAC-CE is to activate or indicate the different TCI states associated with the SBFD symbols/slots and/or the non-SBFD symbols/slots.

In another aspect, a value of a second reserved bit in each MAC-CE to the UE may indicate that the different TCI states are associated with a joint TCI state pool (e.g., that is common to a set of different joint uplink and downlink TCI states) or a separate TCI state pool (e.g., that is common to a set of different uplink states or a set of different downlink TCI states). For example, a MAC-CE may use one more reserved bit to indicate whether the MAC-CE is from the joint TCI state pool or the separate TCI state pool (e.g., if a TCI code point maps to one TCI state whether it represents joint TCI or downlink TCI).

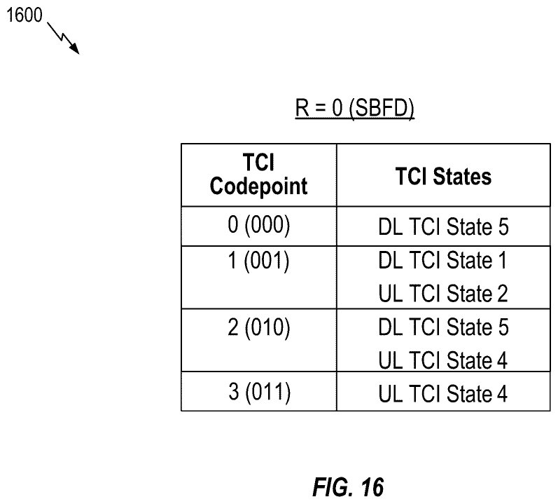

FIG. 16 depicts a table 1600 illustrating mapping of TCI code points and TCI states for SBFD communications (e.g., when a value of a reserved bit in a MAC-CE is equal to 0). As depicted, TCI code point corresponding to 0 (000) indicates downlink TCI state 5, TCI code point corresponding to 1 (001) indicates downlink TCI state 1 and uplink TCI state 2, TCI code point corresponding to 2 (010) indicates downlink TCI state 5 and uplink TCI state 4, and TCI code point corresponding to 3 (011) indicates uplink TCI state 4.

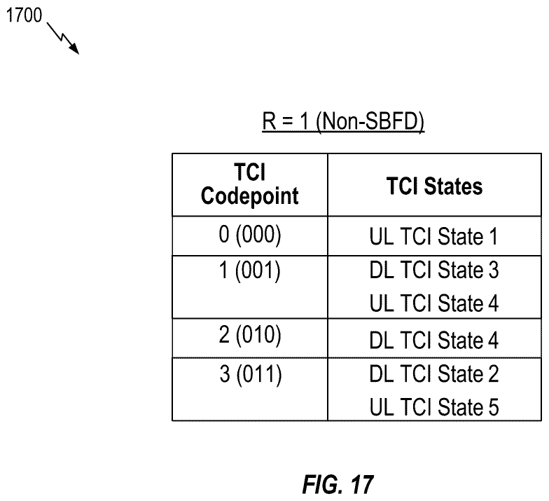

FIG. 17 depicts a table 1700 illustrating mapping of TCI code points and TCI states for non-SBFD communications (e.g., when a value of a reserved bit in a MAC-CE is equal to 1). As depicted, TCI code point corresponding to 0 (000) indicates uplink TCI state 1, TCI code point corresponding to 1 (001) indicates downlink TCI state 3 and uplink TCI state 4, TCI code point corresponding to 2 (010) indicates downlink TCI state 4, and TCI code point corresponding to 3 (011) indicates downlink TCI state 2 and uplink TCI state 5.

In certain aspects, the gNB may send to the UE the configuration indicating the transmission parameters via a DCI message. The transmission parameters may indicate different power control parameters associated with different uplink transmissions. For example, if per UE per channel based configured uplink power control, a DCI may indicate different uplink power control parameters for a PUSCH for the SBFD symbols/slots (e.g., when scheduling different downlink and uplink UEs with different interference levels). In such cases, the UE may transmit the different uplink transmissions in accordance with the different power control parameters.

In certain aspects, the gNB may send to the UE a single MAC-CE to activate or indicate different TCI states associated with the SBFD symbols/slots and/or the non-SBFD symbols/slots. In one aspect, the gNB may use the single MAC-CE to activate the different TCI states associated with the SBFD symbols/slots and the non-SBFD symbols/slots. In another aspect, the gNB may send the single MAC-CE to indicate the different TCI states associated with the SBFD symbols/slots and the non-SBFD symbols/slots. In another aspect, the gNB may send the single MAC-CE to indicate activated different TCI states associated with the SBFD symbols/slots and the non-SBFD symbols/slots. For example, when the RRC may configure multiple uplink TCI states or a downlink TCI state or a joint TCI state under the unified TCI framework; then one MAC-CE may activate multiple TCI code points for the SBFD symbols/slots and the non-SBFD symbols/slots, and indicate whether each TCI code point is applicable for the SBFD symbols/slots or the non-SBFD symbols/slots. The UE may implicitly apply corresponding duplex TCI state(s) based on an SBFD time configuration indication. A single TCI code point may map to up to 2 TCI states.

The UE may send to the gNB capability information indicating a capability to support the single MAC-CE that is configured to activate sixteen TCI states associated with the SBFD symbols/slots and/or the non-SBFD symbols/slots. The gNB may then send to the UE the single MAC-CE that is configured to activate the sixteen TCI states in accordance with the capability information of the UE. First eight TCI states may be associated with the SBFD symbols/slots and other eight TCI states may be associated with the non-SBFD symbols/slots. For example, the RRC may configure a MAC-CE activation/deactivation with up to 16 TCI states (e.g., eight for the SBFD symbols/slots and eight for the non-SBFD symbols/slots). For this purpose, a new MAC-CE with a new sub-header with a logical channel identification (LCID) may be defined and a new UE capability may be required to support such enhancement or not.

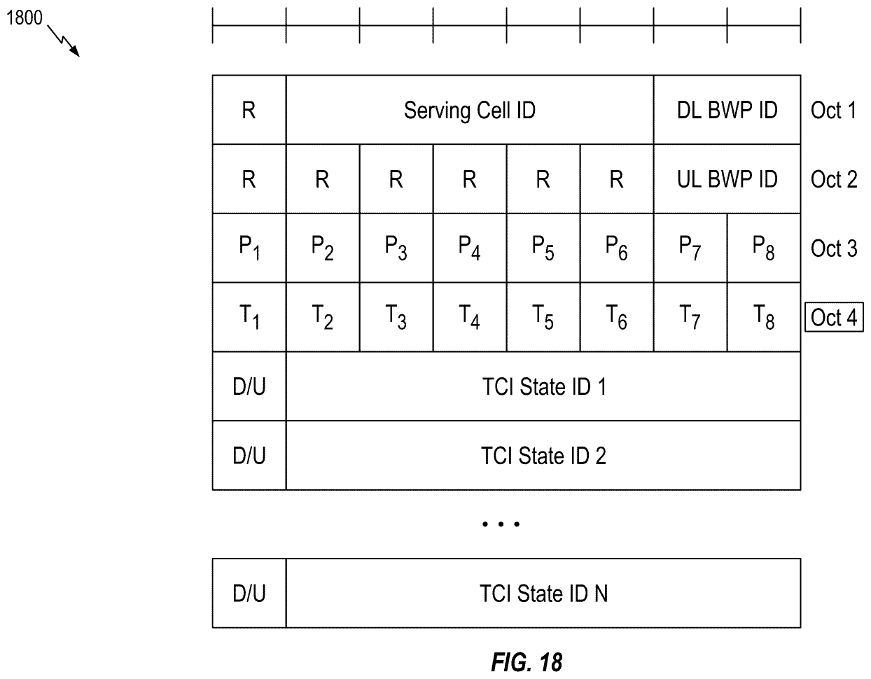

The single MAC-CE may include a bit field per TCI code point. The bit field per TCI code point may indicate that the different TCI states corresponding to the TCI code point are associated with the SBFD symbols/slots or the non-SBFD symbols/slots. For example, as illustrated in a diagram 1800 of FIG. 18, a new bit field Tᵢ (i=1:8) per code point in a MAC-CE may indicate whether TCI states of a TCI code point (i) are applicable for the SBFD symbols/slots or the non-SBFD symbols/slots. Ti being equal to 0 may indicate that the TCI states of a code point (i) is non-SBFD-only and Ti being equal to 1 may indicate that the TCI states of a code point (i) is SBFD-only.

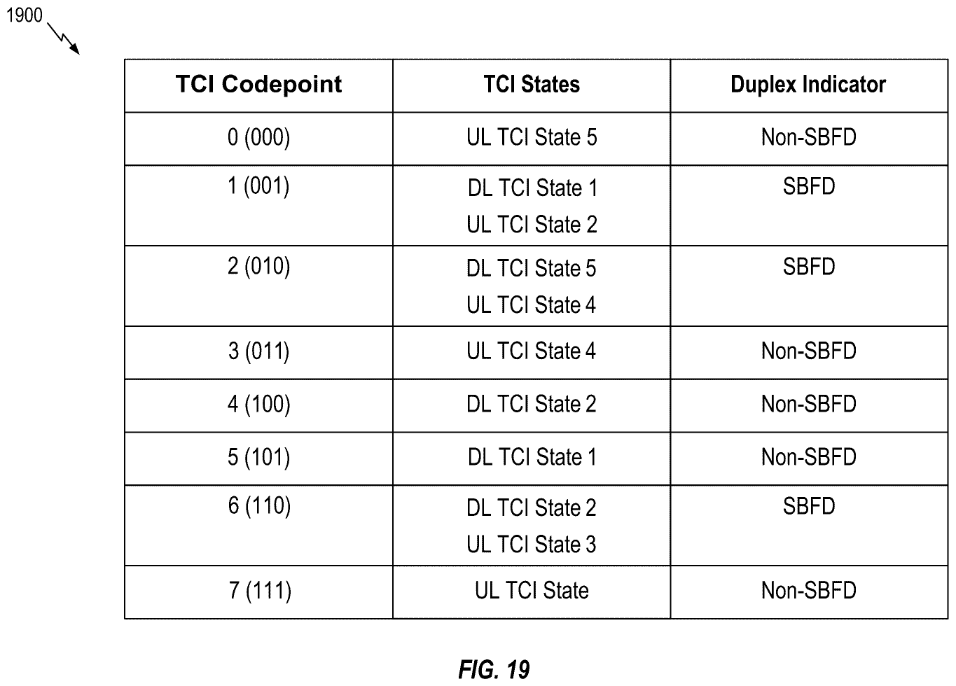

FIG. 19 depicts a table 1900 illustrating mapping of mapping of TCI code points, TCI states, and duplex indicators. As depicted, TCI code point corresponding to 0 (000) indicates uplink TCI state 5 and a duplex indicator of a non-SBFD, TCI code point corresponding to 1 (001) indicates downlink TCI state 1, uplink TCI state 2 and a duplex indicator of an SBFD, TCI code point corresponding to 2 (010) indicates downlink TCI state 5, uplink TCI state 4 and a duplex indicator of the SBFD, TCI code point corresponding to 3 (011) indicates uplink TCI state 4 and a duplex indicator of the non-SBFD, TCI code point corresponding to 4 (0100) indicates downlink TCI state 2 and a duplex indicator of the non-SBFD, TCI code point corresponding to 5 (101) indicates downlink TCI state 1 and a duplex indicator of the non-SBFD, TCI code point corresponding to 6 (110) indicates downlink TCI state 2, uplink TCI state 3 and a duplex indicator of the SBFD, and TCI code point corresponding to 7 (111) indicates uplink TCI state (e.g., based on any uplink TCI state ID) and a duplex indicator of the non-SBFD.

In certain aspects, the gNB may send to the UE at least one MAC-CE to activate or indicate different TCI states associated with the SBFD symbols/slots and/or the non-SBFD symbols/slots. For example, when the RRC may configure multiple uplink TCI states or a downlink/joint TCI state under the unified TCI framework, then the UE may receive two MAC-CEs (e.g., one MAC-CE per each duplex type). Each MAC-CE may activate one or more TCI code points (e.g., with up to two TCI states per code point) that may be applicable for the SBFD symbols/slots or the non-SBFD symbols/slots.

A value of a reserved bit in a MAC-CE may indicate that the MAC-CE includes the different TCI states associated with the SBFD symbols/slots or the different TCI states associated with the SBFD symbols/slots and the non-SBFD symbols/slots. In one example, a first value of the reserved bit in the MAC-CE may indicate that the MAC-CE is applicable to the different TCI states associated with the SBFD symbols/slots. In another example, a second value of the reserved bit in the MAC-CE may indicate that the MAC-CE is applicable to the different TCI states associated with the SBFD symbols/slots and the non-SBFD symbols/slots.

In some aspects, when a value of a reserved bit in a MAC-CE is equal to zero, it may indicate that the UE may receive two MAC-CEs (e.g., one MAC-CE per each duplex type). When the value of the reserved bit in the MAC-CE is equal to one, it may indicate that the MAC-CE which may be for the SBFD symbols/slots may have an additional payload to append more TCI states/code points for the non-SBFD symbols/slots. This aspect may be applicable for certain use cases. For example, in one of these use cases, the gNB may: schedule traffic for downlink in the SBFD symbols/slots, and schedule uplink traffic in uplink sub band. Also, there may be no interference between uplink and downlink communications and an optimum beam/uplink TCI state for the non-SBFD symbols/slots may be used by the UE (e.g., which may be indicated to the UE by the gNB via the DCI).

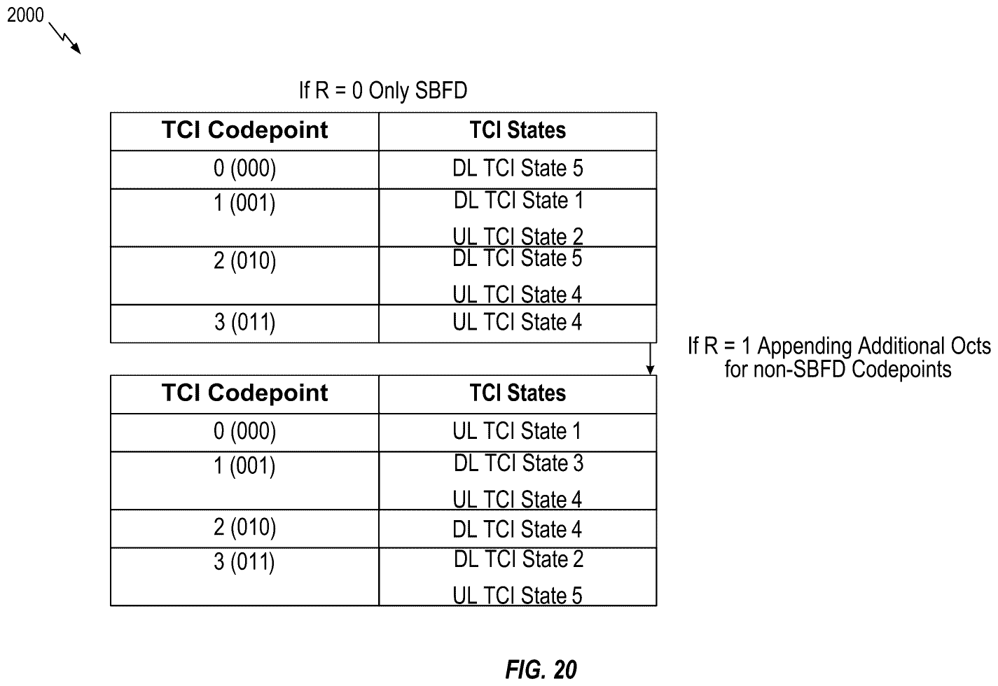

FIG. 20 depicts a table 2000 illustrating mapping of TCI code points and TCI states for SBFD communications (e.g., when a value of a reserved bit in a MAC-CE is equal to 0) and appending for non-SBFD communications (e.g., when a value of a reserved bit in a MAC-CE is equal to 1). As depicted for the SBFD communications, TCI code point corresponding to 0 (000) indicates downlink TCI state 5, TCI code point corresponding to 1 (001) indicates downlink TCI state 1 and uplink TCI state 2, TCI code point corresponding to 2 (010) indicates downlink TCI state 5 and uplink TCI state 4, and TCI code point corresponding to 3 (011) indicates uplink TCI state 4. As depicted for the non-SBFD communications, TCI code point corresponding to 0 (000) indicates uplink TCI state 1, TCI code point corresponding to 1 (001) indicates downlink TCI state 3 and uplink TCI state 4, TCI code point corresponding to 2 (010) indicates downlink TCI state 4, and TCI code point corresponding to 3 (011) indicates downlink TCI state 2 and uplink TCI state 5.

In certain aspects, the gNB may send to the UE a MAC-CE to activate or indicate different TCI states associated with the SBFD symbols/slots and/or the non-SBFD symbols/slots. The MAC-CE may have a multi DCI (mDCI)-based multi TRP (mTRP) MAC-CE format. For example, when the RRC may configure multiple uplink TCI states or a downlink TCI state or a joint TCI state under the unified TCI framework, then the MAC-CE with a mTRP MAC-CE format may be used but reinterpret TCI state 1, 2 for TRP 1, 2 as TCI state 1, 2 for the non-SBFD symbols/slots and the SBFD symbols/slots. Using the MAC-CE with the mTRP MAC-CE format for activating/indicating the different TCI states associated with the SBFD symbols/slots and the non-SBFD symbols/slots may have no signaling impact, and may only require reinterpretation (e.g., reinterpret indicated TCI state 1, 2 for TRP 1, 2 via the MAC-CE as TCI state 1, 2 for the non-SBFD and SBFD symbols/slots). When SBFD communications may extend to mTRP, then two MAC-CEs may be used (e.g., one MAC-CE per TRP with a new indication bit field).

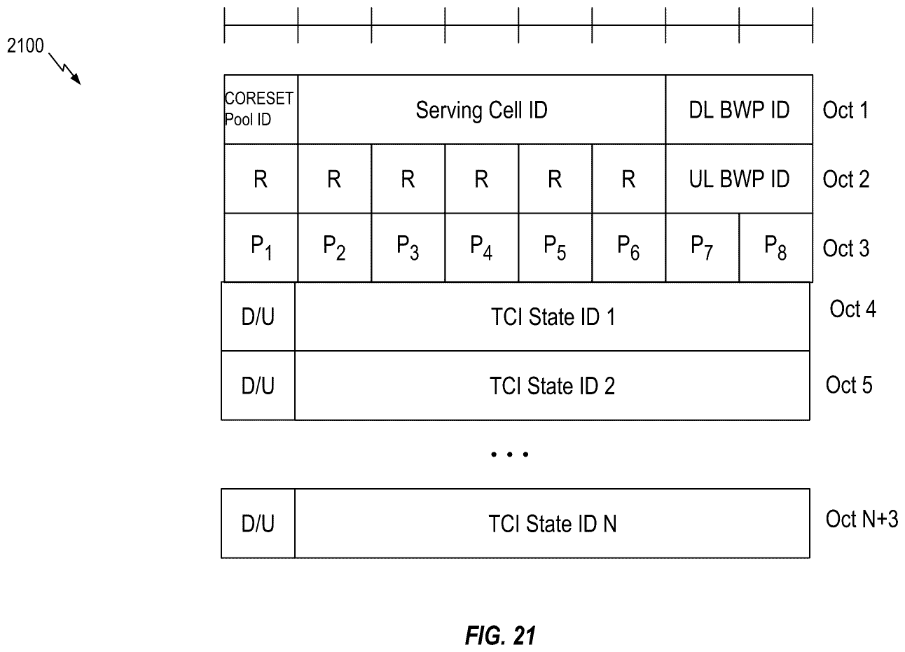

As illustrated in a diagram 2100 of FIG. 21, a MAC-CE may include a control resource set (CORESET) pool ID field. The CORESET pool ID field may indicate that a mapping between activated TCI states and a code point of a DCI TCI set by a field TCI state ID is specific to a duplex type. A value of the CORESET pool ID field may indicate that the different TCI states are associated with the SBFD symbols/slots or the non-SBFD symbols/slots. For example, a first value (e.g., 1) of the CORESET pool ID field in the MAC-CE may indicate that the different TCI states are associated with the SBFD symbols and a second value (e.g., 0) of the CORESET pool ID field in the MAC-CE may indicate that the different TCI states are associated with the non-SBFD symbols/slots.

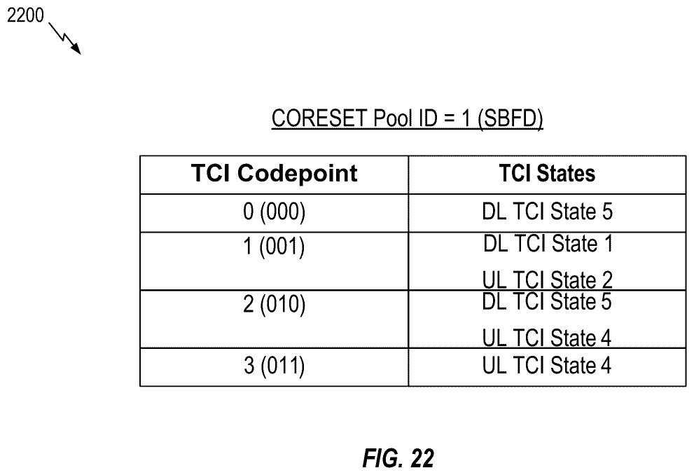

FIG. 22 depicts a table 2200 illustrating mapping of TCI code points and TCI states for SBFD communications based on the first value (e.g., 1) of the CORESET pool ID in the MAC-CE. As depicted, TCI code point corresponding to 0 (000) indicates downlink TCI state 5, TCI code point corresponding to 1 (001) indicates downlink TCI state 1 and uplink TCI state 2, TCI code point corresponding to 2 (010) indicates downlink TCI state 5 and uplink TCI state 4, and TCI code point corresponding to 3 (011) indicates uplink TCI state 4.

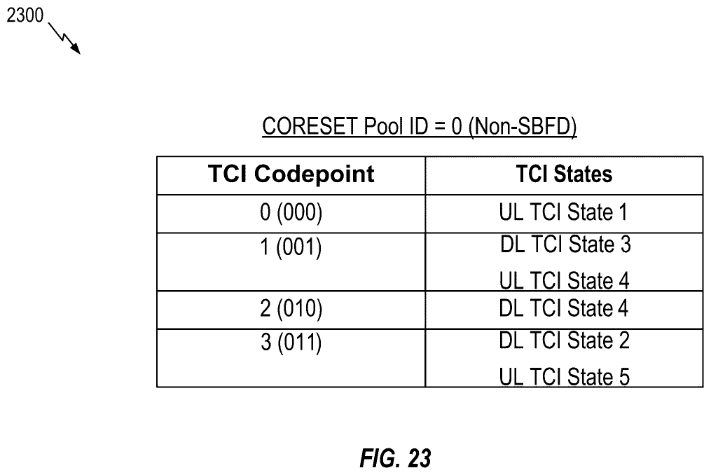

FIG. 23 depicts a table 2300 illustrating mapping of TCI code points and TCI states for non-SBFD communications based on the second value (e.g., 0) of the CORESET pool ID in the MAC-CE. As depicted, TCI code point corresponding to 0 (000) indicates uplink TCI state 1, TCI code point corresponding to 1 (001) indicates downlink TCI state 3 and uplink TCI state 4, TCI code point corresponding to 2 (010) indicates downlink TCI state 4, and TCI code point corresponding to 3 (011) indicates downlink TCI state 2 and uplink TCI state 5.

In certain aspects, the gNB may send to the UE a MAC-CE to activate or indicate joint uplink and downlink TCI states associated with the SBFD symbols/slots and/or the non-SBFD symbols/slots. The MAC-CE may have a single DCI (sDCI)-based mTRP MAC-CE format (e.g., for joint TCI states). A value of a field in the MAC-CE may indicate that the joint uplink and downlink TCI states are associated with the SBFD symbols/slots or the non-SBFD symbols/slots. For example, a first value of the field in the MAC-CE may indicate that the joint uplink and downlink TCI states are associated with the SBFD symbols/slots and a second value of the field in the MAC-CE may indicate that the joint uplink and downlink TCI states are associated with the non-SBFD symbols/slots.

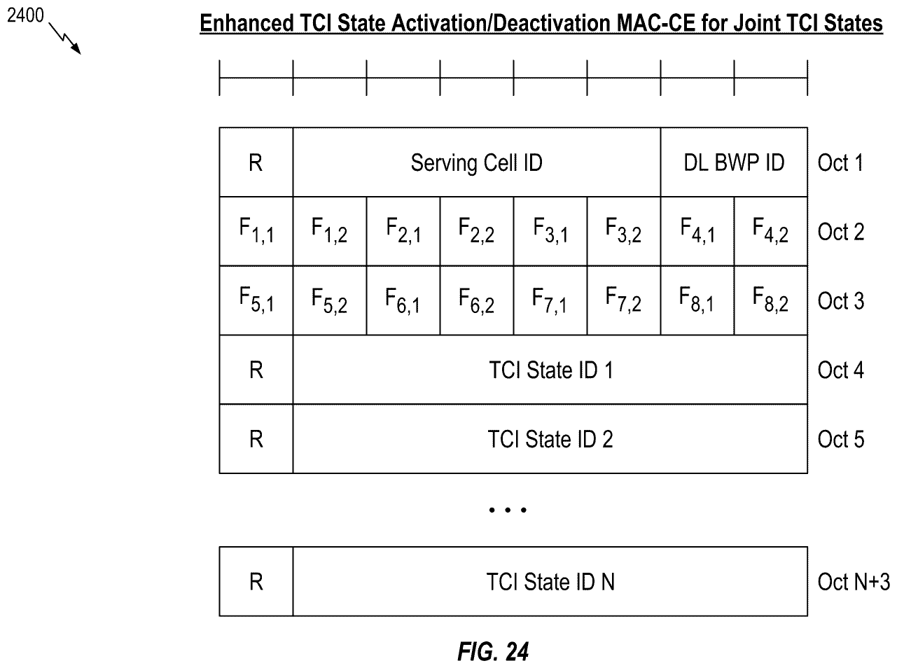

As illustrated in a diagram 2400 of FIG. 24, a MAC-CE may include a field (F_{i,j}). The F_{i,j} field may indicate for TCI state ID fields associated with a code point i of a DCI TCI field whether j-th joint TCI state is present or not, where j=1, 2. A j field set to 1 may indicate that the TCI states are specified to the non-SBFD symbols/slots, otherwise the TCI states are specified to the SBFD symbols/slots. If F_{i,j} field is set to 1, it indicates the j-th joint TCI state for code point i is present. If F_{i,j} field is set to 0, it indicates the j-th joint TCI state for code point i is absent. The code point to which a TCI state is mapped is determined by its ordinal position among all the TCI state ID fields.

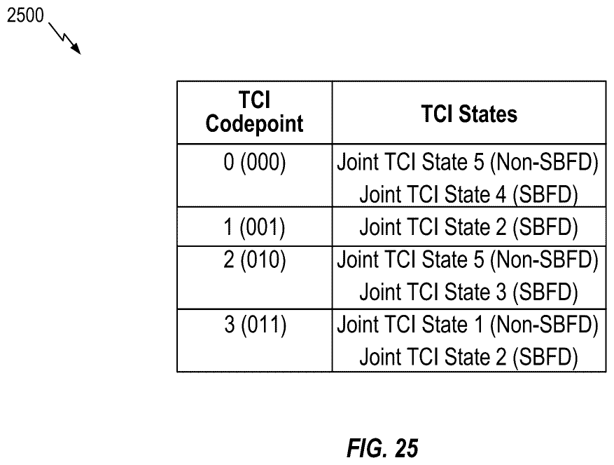

FIG. 25 depicts a table 2500 illustrating mapping of TCI code points and TCI states activated/deactivated using a MAC-CE with a sDCI-based mTRP MAC-CE format. As depicted, TCI code point corresponding to 0 (000) indicates a joint uplink and downlink TCI state 5 (for non-SBFD symbols/slots) and a joint TCI uplink and downlink TCI state 4 (for SBFD symbols/slots); TCI code point corresponding to 1 (001) a joint TCI uplink and downlink TCI state 2 (for SBFD symbols/slots); TCI code point corresponding to 2 (010) indicates a joint uplink and downlink TCI state 5 (for non-SBFD symbols/slots) and a joint TCI uplink and downlink TCI state 3 (for SBFD symbols/slots); and TCI code point corresponding to 3 (011) indicates a joint uplink and downlink TCI state 1 (for non-SBFD symbols/slots) and a joint TCI uplink and downlink TCI state 2 (for SBFD symbols/slots).

In certain aspects, the gNB may send to the UE a MAC-CE to activate or indicate separate uplink and downlink TCI states associated with the SBFD symbols/slots and/or the non-SBFD symbols/slots. The MAC-CE may have a sDCI-based mTRP MAC-CE format (e.g., for separate TCI states). A value of a first field in the MAC-CE may indicate that uplink TCI states are associated with the SBFD symbols/slots or the non-SBFD symbols/slots. A value of a second field in the MAC-CE may indicate that downlink TCI states are associated with the SBFD symbols/slots or the non-SBFD symbols/slots.

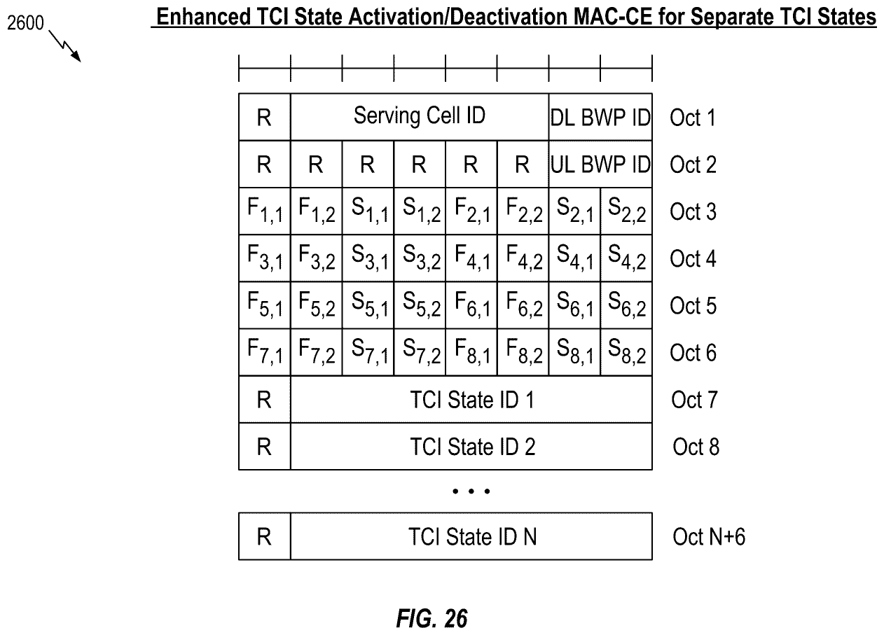

As illustrated in a diagram 2600 of FIG. 26, a MAC-CE may include a first field (F_{i,j}) and a second field (S_{i,j}). The F_{i,j} field may indicate for TCI state ID fields associated with a code point i of DCI TCI field whether j-th DL TCI state is present or not, where j=1, 2. A j field set to 1 indicates that the TCI states are specified to the non-SBFD symbols/slots, otherwise the TCI states are specified to the SBFD symbols/slots. If F_{i,j} field is set to 1, it indicates j-th downlink TCI state for code point i is present. If F_{i,j} field is set to 0, it indicates the j-th downlink TCI state for code point i is absent. The S_{i,j} field may indicate for TCI state ID fields associated with a code point i of a DCI TCI field whether a j-th uplink TCI state is present or not, where j=1, 2. A j field set to 1 indicates that the TCI states are specified to non-SBFD symbols/slots, otherwise the TCI states are specified to the SBFD symbols/slots. If S_{i,j} field is set to 1, it indicates j-th uplink TCI state for code point i is present. If S_{i,j} field is set to 0, it indicates the j-th uplink TCI state for code point i is absent.

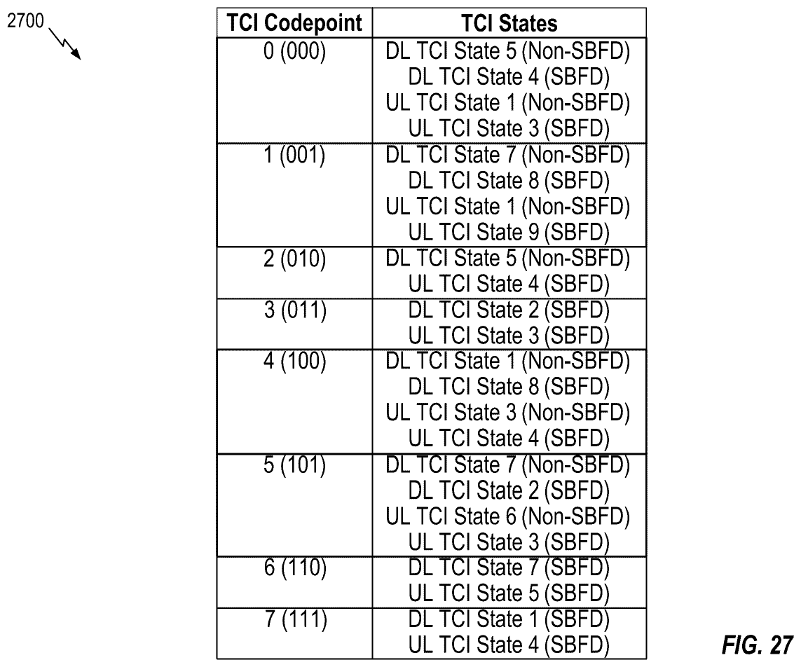

FIG. 27 depicts a table 2700 illustrating mapping of TCI code points and TCI states activated/deactivated using a MAC-CE with a sDCI-based mTRP MAC-CE format. As depicted, TCI code point corresponding to 0 (000) indicates downlink TCI state 5 (for non-SBFD symbols/slots), downlink TCI state 4 (for SBFD symbols/slots), uplink TCI state 1 (for non-SBFD symbols/slots), and uplink TCI state 3 (for SBFD symbols/slots). TCI code point corresponding to 1 (001) indicates downlink TCI state 7 (for non-SBFD symbols/slots), downlink TCI state 8 (for SBFD symbols/slots), uplink TCI state 1 (for non-SBFD symbols/slots), and uplink TCI state 9 (for SBFD symbols/slots). TCI code point corresponding to 2 (010) indicates uplink TCI state 5 (for non-SBFD symbols/slots) and uplink TCI state 4 (for SBFD symbols/slots). TCI code point corresponding to 3 (011) indicates downlink TCI state 2 (for SBFD symbols/slots) and uplink TCI state 3 (for SBFD symbols/slots). TCI code point corresponding to 4 (100) indicates downlink TCI state 1 (for non-SBFD symbols/slots), downlink TCI state 8 (for SBFD symbols/slots), uplink TCI state 3 (for non-SBFD symbols/slots), and uplink TCI state 4 (for SBFD symbols/slots). TCI code point corresponding to 5 (101) indicates downlink TCI state 7 (for non-SBFD symbols/slots), downlink TCI state 2 (for SBFD symbols/slots), uplink TCI state 6 (for non-SBFD symbols/slots), and uplink TCI state 3 (for SBFD symbols/slots). TCI code point corresponding to 6 (110) downlink TCI state 7 (for SBFD symbols/slots) and uplink TCI state 5 (for SBFD symbols/slots). TCI code point corresponding to 7 (111) indicates downlink TCI state 1 (for SBFD symbols/slots) and uplink TCI state 4 (for SBFD symbols/slots).

In certain aspects, the gNB may send to the UE a MAC-CE or a DCI to activate or indicate TCI states associated with the SBFD symbols/slots and the non-SBFD symbols/slots. The SBFD symbols/slots and the non-SBFD symbols/slots may be associated with a set of CCs in a CC list. For example, an applied CC in the MAC-CE/DCI to active/indicate the TCI state(s) for the SBFD symbols/slots and the non-SBFD symbols/slots on all CCs in the CC list.

In certain aspects, the gNB may send to the UE, via a MAC-CE or a DCI, separate uplink TCI states associated with the SBFD symbols/slots and the non-SBFD symbols/slots. For example, the UE may not expect to receive different downlink TCI states in the SBFD symbols/slots and the non-SBFD symbols/slots, but the UE is allowed to be configured with separate uplink TCI states in the SBFD symbols/slots and the non-SBFD symbols/slots based on the unified TCI framework. The uplink TCI states may need quasi-colocation (QCL) type D. In some cases, if a joint TCI state is configured, it is for downlink TCI state only, and the UE is allowed to be configured with the separate uplink TCI states in the SBFD symbols/slots and the non-SBFD symbols/slots.

In certain aspects, the UE may send to the gNB capability information indicating its capability to support separate power control parameters with a same beam associated with the SBFD symbols/slots and the non-SBFD symbols/slots. For example, an SBFD-aware UE may report its capability to support separate uplink power control with the same beam in the SBFD symbols/slots and the non-SBFD symbols/slots based on the unified TCI framework. The gNB may then send the transmission parameters to the UE, in accordance with this capability information of the UE.

In certain aspects, the UE may send to the gNB capability information indicating its capability to support separate power control parameters with a same downlink TCI state and separate uplink TCI states associated with the SBFD symbols/slots and the non-SBFD symbols/slots. For example, the SBFD-aware UE may report its capability to support separate uplink power control with the same downlink TCI state in the SBFD symbols/slots and the non-SBFD symbols/slots, but support the separate uplink TCI states in the SBFD symbols/slots and the non-SBFD symbols/slots based on the unified TCI framework. The gNB may then send the transmission parameters to the UE, in accordance with this capability information of the UE.

In certain aspects, the UE may send to the gNB capability information indicating its capability to support separate power control parameters with separate downlink and uplink TCI states associated with the SBFD symbols/slots and the non-SBFD symbols/slots. For example, the SBFD-aware UE may report its capability to support separate uplink power control with the separate downlink and uplink TCI states in the SBFD symbols/slots and the non-SBFD symbols/slots based on the unified TCI framework. The gNB may then send the transmission parameters to the UE, in accordance with this capability information of the UE.

In certain aspects, the UE may send to the gNB capability information indicating its capability to support a quantity of downlink TCI states, uplink TCI states, and/or joint uplink and downlink TCI states, per at least one of the SBFD symbols/slots or the non-SBFD symbols/slots, per CC or multiple CCs. For example, the capability information may indicate: a total number of configured downlink TCI states, uplink TCI states, joint TCI states per CC or across CC; and/or a total number of configured downlink TCI states, uplink TCI states, joint TCI states (per SBFD and per non-SBFD) per CC or across CC. The gNB may then send the transmission parameters to the UE, in accordance with this capability information of the UE.

In certain aspects, the gNB may send a sTRP unified TCI framework configuration and a mTRP unified TCI framework configuration to the UE. In one example, the UE may transmit the capability information to the gNB based on the sTRP unified TCI framework configuration. In another example, the UE may transmit the capability information to the gNB based on the mTRP unified TCI framework configuration.

### Example Method for Wireless Communications at a UE

FIG. 28 shows an example of a method 2800 for wireless communications at a wireless node for managing transmissions on different symbols or slots. The wireless node is a user equipment (UE), such as the UE 104 of FIG. 1 and FIG. 3. In some cases, the wireless node may be a network entity, such as the BS 102 of FIG. 1 and FIG. 3.

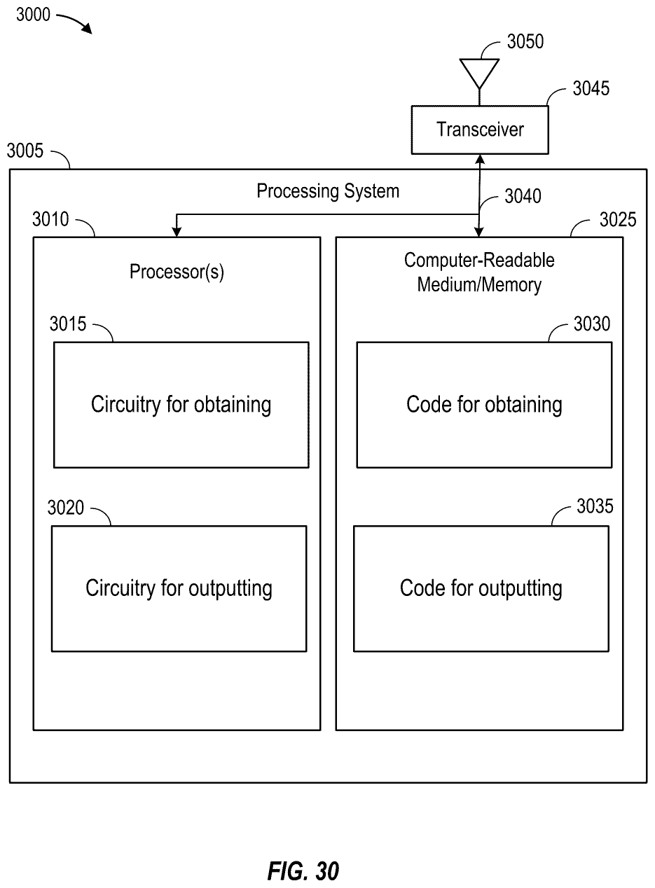

Method 2800 begins at step 2810 with obtaining (e.g., by the UE from the network entity) a configuration indicating one or more transmission parameters associated with full duplex (FD) symbols and non-FD symbols. The one or more transmission parameters indicate at least one of: power control parameters or a unified transmission configuration indicator (TCI). In some cases, the operations of this step refer to, or may be performed by, circuitry for obtaining and/or code for obtaining as described with reference to FIG. 30.

Method 2800 then proceeds to step 2820 with outputting (e.g., by the UE to the network entity) one or more uplink channels for transmission, in accordance with the obtained configuration. In some cases, the operations of this step refer to, or may be performed by, circuitry for outputting and/or code for outputting as described with reference to FIG. 30.

In certain aspects, the FD symbols include sub-band full duplex (SBFD) symbols and the non-FD symbols include non-SBFD symbols.

In certain aspects, the unified TCI indicates a joint uplink and downlink TCI state or separate uplink and downlink TCI states.

In certain aspects, the power control parameters include at least one of a received power target value, a power control factor value, or a closed-loop power control value.

In certain aspects, the one or more transmission parameters indicate different sets of the power control parameters. The method 2800 further includes outputting the one or more uplink channels for the transmission on the FD symbols and the non-FD symbols in accordance with the different sets of the power control parameters.

In certain aspects, the one or more transmission parameters indicate a single set of the power control parameters and a power control offset value. The method 2800 further includes outputting the one or more uplink channels for the transmission on the FD symbols in accordance with the single set of the power control parameters and on the non-FD symbols in accordance with the single set of the power control parameters and the power control offset value.

In certain aspects, the power control offset value indicates a difference between a first transmission power value associated with the FD symbols and a second transmission power value associated with the non-FD symbols. The method 2800 further includes obtaining a medium access control—control element (MAC-CE) or a downlink control information (DCI) indicating an adjustment of the power control offset value.

In certain aspects, the one or more transmission parameters indicate at least one of a same downlink beam or a same uplink beam associated with the FD symbols and the non-FD symbols. The method 2800 further includes outputting the one or more channels (e.g., such as uplink channels) for the transmission on the FD symbols and the non-FD symbols using a beam (e.g., such as the same downlink beam and/or the same uplink beam).

In certain aspects, the one or more transmission parameters indicate at least one of separate downlink beams or separate uplink beams associated with the FD symbols and the non-FD symbols.

In certain aspects, the method 2800 further includes outputting one or more channels (e.g., such as the one or more uplink channels) for the transmission on the FD symbols and the non-FD symbols using one or more beams (e.g., the separate downlink beams and/or the separate uplink beams).

In certain aspects, the one or more transmission parameters indicate different TCI state types. The method 2800 further includes outputting the one or more uplink channels for the transmission on the FD symbols and the non-FD symbols associated with the different TCI state types.

In certain aspects, each TCI state type indicates separate uplink and downlink TCI states or a joint uplink and downlink TCI state.

In certain aspects, the separate uplink and downlink TCI states indicate an uplink TCI state and a downlink TCI state.

In certain aspects, the joint uplink and downlink TCI state and the downlink TCI state are associated with different TCI pools.

In certain aspects, the joint uplink and downlink TCI state and the downlink TCI state are associated with a same TCI pool.

In certain aspects, the one or more transmission parameters indicate a same TCI state type. The method 2800 further includes outputting the one or more uplink channels for the transmission on the FD symbols and the non-FD symbols associated with the same TCI state type.

In certain aspects, the same TCI state type indicates separate uplink and downlink TCI states.

In certain aspects, the method 2800 further includes obtaining a radio resource control (RRC) signaling configuring multiple TCI pools associated with multiple TCI states associated with the FD symbols and the non-FD symbols. The method 2800 further includes outputting the one or more uplink channels for the transmission on the FD symbols and the non-FD symbols associated with the multiple TCI states.

In certain aspects, when the multiple TCI pools are associated with a first component carrier (CC) of a set of CCs, the multiple TCI pools are associated with all other CCs in the set of CCs.

In certain aspects, the method 2800 further includes obtaining different MAC-CEs to activate or indicate different TCI states associated with the FD symbols and the non-FD symbols. The method 2800 further includes outputting the one or more uplink channels for the transmission on the FD symbols and the non-FD symbols associated with the different TCI states activated or indicated by the different MAC-CEs.

In certain aspects, a value of a first reserved bit in each MAC-CE indicates that the MAC-CE is to activate or indicate the different TCI states associated with the FD symbols or the non-FD symbols.

In certain aspects, a value of a second reserved bit in each MAC-CE indicates that the different TCI states in the MAC-CE are associated with a joint TCI pool that is common to a set of different joint uplink and downlink TCI states or a separate TCI pool that is common to a set of different uplink or downlink TCI states.

In certain aspects, the method 2800 further includes obtaining a DCI message indicating the one or more transmission parameters. The one or more transmission parameters indicate different power control parameters associated with different uplink channels. The method 2800 further includes outputting the different uplink channels in accordance with the different power control parameters.

In certain aspects, the method 2800 further includes obtaining a single MAC-CE to activate or indicate different TCI states associated with the FD symbols and the non-FD symbols. The method 2800 further includes outputting the one or more uplink channels for the transmission on the FD symbols and the non-FD symbols associated with the different TCI states activated or indicated by the single MAC-CE.

In certain aspects, the method 2800 further includes outputting capability information to support the single MAC-CE activating up to sixteen TCI states associated with the FD symbols and the non-FD symbols.

In certain aspects, the method 2800 further includes obtaining the single MAC-CE activating up to sixteen TCI states in accordance with the capability information of the UE. The first eight TCI states are associated with the FD symbols and other eight TCI states are associated with the non-FD symbols.

In certain aspects, the single MAC-CE comprises a bit field per TCI code point. The bit field per TCI code point indicates that TCI states corresponding to the TCI code point are associated with the FD symbols or the non-FD symbols.

In certain aspects, the method 2800 further includes obtaining a MAC-CE to activate or indicate different TCI states associated with the FD symbols and the non-FD symbols. A value of a reserved bit in the MAC-CE indicates that the MAC-CE comprises the TCI states associated with the FD symbols or the TCI states associated with FD symbols and the non-FD symbols.

In certain aspects, a first value of the reserved bit in the MAC-CE indicates that the MAC-CE is applicable to the TCI states associated with the FD symbols; and a second value of the reserved bit in the MAC-CE indicates that the MAC-CE is applicable to the TCI states associated with the FD symbols and the non-FD symbols.

In certain aspects, the method 2800 further includes obtaining a MAC-CE with a multi DCI (mDCI)-based multi transmit receive point (mTRP) MAC-CE format to activate or indicate different TCI states associated with the FD symbols and the non-FD symbols. The method 2800 further includes outputting the one or more uplink channels for the transmission on the FD symbols and the non-FD symbols associated with the different TCI states activated or indicated by the MAC-CE with the mDCI-based mTRP MAC-CE format. In certain aspects, a value of a control resource set (CORESET) pool identification (ID) field in the MAC-CE indicates that the TCI states are associated with the FD symbols or the non-FD symbols.

In certain aspects, a first value of the CORESET pool ID field in the MAC-CE indicates that the TCI states are associated with the FD symbols and a second value of the CORESET pool ID field in the MAC-CE indicates that the TCI states are associated with the non-FD symbols.

In certain aspects, the method 2800 further includes obtaining a MAC-CE with a single DCI (sDCI)-based mTRP MAC-CE format to activate or indicate joint uplink and downlink TCI states associated with the FD symbols and the non-FD symbols. The method 2800 further includes outputting the one or more uplink channels for the transmission on the FD symbols and the non-FD symbols associated with the joint uplink and downlink TCI states activated or indicated by the MAC-CE with the sDCI-based mTRP MAC-CE format.

In certain aspects, a value of a field in the MAC-CE indicates that the joint uplink and downlink TCI states are associated with the FD symbols or the non-FD symbols.

In certain aspects, a first value of the field in the MAC-CE indicates that the joint uplink and downlink TCI states are associated with the FD symbols and a second value of the field in the MAC-CE indicates that the joint uplink and downlink TCI states are associated with the non-FD symbols.

In certain aspects, the method 2800 further includes obtaining a MAC-CE with a sDCI-based mTRP MAC-CE format to activate or indicate separate uplink and downlink TCI states associated with the FD symbols and the non-FD symbols. The method 2800 further includes outputting the one or more uplink channels for the transmission on the FD symbols and the non-FD symbols associated with the separate uplink and downlink TCI states activated or indicated by the MAC-CE with the sDCI-based mTRP MAC-CE format.

In certain aspects, a value of a first field in the MAC-CE indicates that uplink TCI states are associated with the FD symbols or the non-FD symbols.

In certain aspects, a value of a second field in the MAC-CE indicates that downlink TCI states are associated with the FD symbols or the non-FD symbols.

In certain aspects, the method 2800 further includes obtaining a MAC-CE or a DCI to activate or indicate TCI states associated with the FD symbols and the non-FD symbols. The FD symbols and the non-FD symbols are associated with a set of CCs in a CC list. The method 2800 further includes outputting the one or more uplink channels for the transmission on the FD symbols and the non-FD symbols associated with the TCI states activated or indicated by the MAC-CE.

In certain aspects, the method 2800 further includes obtaining, via a MAC-CE or a DCI, separate uplink TCI states associated with the FD symbols and the non-FD symbols. The method 2800 further includes outputting the one or more uplink channels for the transmission on the FD symbols and the non-FD symbols associated with the separate uplink TCI states obtained via the MAC-CE or the DCI.

In certain aspects, the method 2800 further includes outputting capability information indicating a capability to support separate power control parameters with a same beam associated with the FD symbols and the non-FD symbols. The method 2800 further includes obtaining the one or more transmission parameters in accordance with the capability information.

In certain aspects, the method 2800 further includes outputting capability information indicating a capability to support separate power control parameters with a same downlink TCI state and separate uplink TCI states associated with the FD symbols and the non-FD symbols. The method 2800 further includes obtaining the one or more transmission parameters in accordance with the capability information.

In certain aspects, the method 2800 further includes outputting capability information indicating a capability to support separate power control parameters with separate downlink and uplink TCI states associated with the FD symbols and the non-FD symbols. The method 2800 further includes obtaining the one or more transmission parameters in accordance with the capability information.

In certain aspects, the method 2800 further includes obtaining a sTRP unified TCI framework configuration and outputting the capability information in accordance with the sTRP unified TCI framework configuration.

In certain aspects, the method 2800 further includes obtaining a mTRP unified TCI framework configuration and outputting the capability information in accordance with the mTRP unified TCI framework configuration.

In certain aspects, the method 2800 further includes outputting capability information indicating a capability to support a quantity of at least one of: downlink TCI states, uplink TCI states, or joint uplink and downlink TCI states, per at least one of the FD symbols or the non-FD symbols, per CC or across multiple CCs. The method 2800 further includes obtaining the one or more transmission parameters in accordance with the capability information.

In one aspect, the method 2800, or any aspect related to it, may be performed by an apparatus, such as a communications device 3000 of FIG. 30, which includes various components operable, configured, or adapted to perform the method 2800. The communications device 3000 is described below in further detail.

Note that FIG. 28 is just one example of a method, and other methods including fewer, additional, or alternative steps are possible consistent with this disclosure.

### Example Method for Wireless Communications at a Network Entity

FIG. 29 shows an example of a method 2900 for wireless communications at a wireless node for uplink transmissions on different symbols or slots. The wireless node is a network entity, such as the BS 102 of FIG. 1 and FIG. 3. In some cases, the wireless node may be a user equipment (UE), such as the UE 104 of FIG. 1 and FIG. 3.

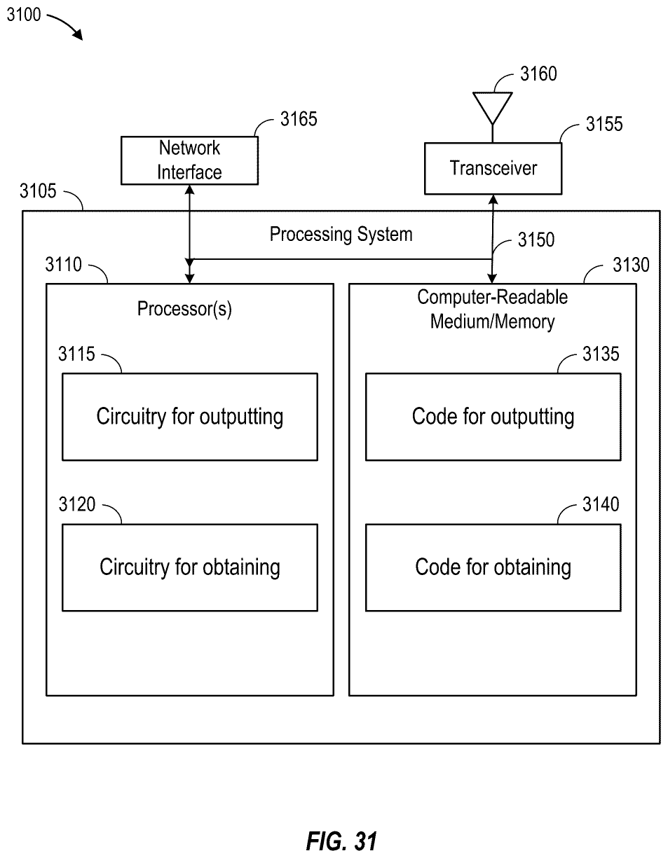

Method 2900 begins at step 2910 with outputting (e.g., by the network entity to the UE) a configuration indicating one or more transmission parameters associated with full duplex (FD) symbols and non-FD symbols. The one or more transmission parameters indicate at least one of: power control parameters or a unified transmission configuration indicator (TCI). In some cases, the operations of this step refer to, or may be performed by, circuitry for outputting and/or code for outputting as described with reference to FIG. 31.

Method 2900 then proceeds to step 2920 with obtaining (e.g., by the network entity from the UE) one or more uplink channels, in accordance with the outputted configuration. In some cases, the operations of this step refer to, or may be performed by, circuitry for obtaining and/or code for obtaining as described with reference to FIG. 31.

In certain aspects, the FD symbols include sub-band full duplex (SBFD) symbols and the non-FD symbols include non-SBFD symbols.

In certain aspects, the unified TCI indicates a joint uplink and downlink TCI state or separate uplink and downlink TCI states.

In certain aspects, the power control parameters include at least one of a received power target value, a power control factor value, or a closed-loop power control value.

In certain aspects, the one or more transmission parameters indicate different sets of the power control parameters. The method 2900 further includes obtaining the one or more uplink channels on the FD symbols and the non-FD symbols in accordance with the different sets of the power control parameters.

In certain aspects, the one or more transmission parameters indicate a single set of the power control parameters and a power control offset value. The method 2900 further includes obtaining the one or more uplink channels on the FD symbols in accordance with the single set of the power control parameters and on the non-FD symbols in accordance with the single set of the power control parameters and the power control offset value.

In certain aspects, the power control offset value indicates a difference between a first transmission power value associated with the FD symbols and a second transmission power value associated with the non-FD symbols. The method 2900 further includes outputting a medium access control—control element (MAC-CE) or a downlink control information (DCI) indicating an adjustment of the power control offset value.

In certain aspects, the one or more transmission parameters indicate at least one of a same downlink beam or a same uplink beam associated with the FD symbols and the non-FD symbols. The method 2900 further includes obtaining the one or more uplink channels on the FD symbols and the non-FD symbols using the at least one of the same downlink beam or the same uplink beam.

In certain aspects, the one or more transmission parameters indicate at least one of separate downlink beams or separate uplink beams associated with the FD symbols and the non-FD symbols.

In certain aspects, the method 2900 further includes obtaining one or more channels (e.g., such as the one or more uplink channels) on the FD symbols and the non-FD symbols using beams (e.g., such as the separate downlink beams and/or the separate uplink beams).

In certain aspects, the one or more transmission parameters indicate different TCI state types. The method 2900 further includes obtaining the one or more uplink channels on the FD symbols and the non-FD symbols associated with the different TCI state types.

In certain aspects, each TCI state type indicates separate uplink and downlink TCI states or a joint uplink and downlink TCI state.

In certain aspects, the separate uplink and downlink TCI states indicate an uplink TCI state and a downlink TCI state.

In certain aspects, the joint uplink and downlink TCI state and the downlink TCI state are associated with different TCI pools.

In certain aspects, the joint uplink and downlink TCI state and the downlink TCI state are associated with a same TCI pool.

In certain aspects, the one or more transmission parameters indicate a same TCI state type. The method 2900 further includes obtaining the one or more uplink channels on the FD symbols and the non-FD symbols associated with the same TCI state type.

In certain aspects, the same TCI state type indicates separate uplink and downlink TCI states.

In certain aspects, the method 2900 further includes outputting a radio resource control (RRC) signaling configuring multiple TCI pools associated with multiple TCI states associated with the FD symbols and the non-FD symbols. The method 2900 further includes obtaining the one or more uplink channels on the FD symbols and the non-FD symbols associated with the multiple TCI states.

In certain aspects, when the multiple TCI pools are associated with a first component carrier (CC) of a set of CCs, the multiple TCI pools are associated with all other CCs in the set of CCs.

In certain aspects, the method 2900 further includes outputting different MAC-CEs to activate or indicate different TCI states associated with the FD symbols and the non-FD symbols. The method 2900 further includes obtaining the one or more uplink channels on the FD symbols and the non-FD symbols associated with the different TCI states activated or indicated by the different MAC-CEs.

In certain aspects, a value of a first reserved bit in each MAC-CE indicates that the MAC-CE is to activate or indicate the different TCI states associated with the FD symbols or the non-FD symbols.

In certain aspects, a value of a second reserved bit in each MAC-CE indicates that the different TCI states in the MAC-CE are associated with a joint TCI pool that is common to a set of different joint uplink and downlink TCI states or a separate TCI pool that is common to a set of different uplink or downlink TCI states.

In certain aspects, the method 2900 further includes outputting a DCI message indicating the one or more transmission parameters. The one or more transmission parameters indicate different power control parameters associated with different uplink channels. The method 2900 further includes obtaining the different uplink channels in accordance with the different power control parameters.

In certain aspects, the method 2900 further includes outputting a single MAC-CE to activate or indicate different TCI states associated with the FD symbols and the non-FD symbols. The method 2900 further includes obtaining the one or more uplink channels on the FD symbols and the non-FD symbols associated with the different TCI states activated or indicated by the single MAC-CE.

In certain aspects, the method 2900 further includes obtaining capability information to support the single MAC-CE activating up to sixteen TCI states associated with the FD symbols and the non-FD symbols.

In certain aspects, the method 2900 further includes outputting the single MAC-CE activating up to sixteen TCI states in accordance with the capability information of the UE. The first eight TCI states are associated with the FD symbols and other eight TCI states are associated with the non-FD symbols.

In certain aspects, the single MAC-CE comprises a bit field per TCI code point. The bit field per TCI code point indicates that TCI states corresponding to the TCI code point are associated with the FD symbols or the non-FD symbols.

In certain aspects, the method 2900 further includes outputting a MAC-CE to activate or indicate different TCI states associated with the FD symbols and the non-FD symbols. A value of a reserved bit in the MAC-CE indicates that the MAC-CE comprises the TCI states associated with the FD symbols or the TCI states associated with FD symbols and the non-FD symbols.

In certain aspects, a first value of the reserved bit in the MAC-CE indicates that the MAC-CE is applicable to the TCI states associated with the FD symbols; and a second value of the reserved bit in the MAC-CE indicates that the MAC-CE is applicable to the TCI states associated with the FD symbols and the non-FD symbols.

In certain aspects, the method 2900 further includes outputting a MAC-CE with a multi DCI (mDCI)-based multi transmit receive point (mTRP) MAC-CE format to activate or indicate different TCI states associated with the FD symbols and the non-FD symbols. The method 2900 further includes obtaining the one or more uplink channels on the FD symbols and the non-FD symbols associated with the different TCI states activated or indicated by the MAC-CE with the mDCI-based mTRP MAC-CE format. In certain aspects, a value of a control resource set (CORESET) pool identification (ID) field in the MAC-CE indicates that the TCI states are associated with the FD symbols or the non-FD symbols.

In certain aspects, a first value of the CORESET pool ID field in the MAC-CE indicates that the TCI states are associated with the FD symbols and a second value of the CORESET pool ID field in the MAC-CE indicates that the TCI states are associated with the non-FD symbols.

In certain aspects, the method 2900 further includes outputting a MAC-CE with a single DCI (sDCI)-based mTRP MAC-CE format to activate or indicate joint uplink and downlink TCI states associated with the FD symbols and the non-FD symbols. The method 2900 further includes obtaining the one or more uplink channels on the FD symbols and the non-FD symbols associated with the joint uplink and downlink TCI states activated or indicated by the MAC-CE with the sDCI-based mTRP MAC-CE format.

In certain aspects, a value of a field in the MAC-CE indicates that the joint uplink and downlink TCI states are associated with the FD symbols or the non-FD symbols.

In certain aspects, a first value of the field in the MAC-CE indicates that the joint uplink and downlink TCI states are associated with the FD symbols and a second value of the field in the MAC-CE indicates that the joint uplink and downlink TCI states are associated with the non-FD symbols.

In certain aspects, the method 2900 further includes outputting a MAC-CE with a sDCI-based mTRP MAC-CE format to activate or indicate separate uplink and downlink TCI states associated with the FD symbols and the non-FD symbols. The method 2900 further includes obtaining the one or more uplink channels on the FD symbols and the non-FD symbols associated with the separate uplink and downlink TCI states activated or indicated by the MAC-CE with the sDCI-based mTRP MAC-CE format.

In certain aspects, a value of a first field in the MAC-CE indicates that uplink TCI states are associated with the FD symbols or the non-FD symbols.

In certain aspects, a value of a second field in the MAC-CE indicates that downlink TCI states are associated with the FD symbols or the non-FD symbols.

In certain aspects, the method 2900 further includes outputting a MAC-CE or a DCI to activate or indicate TCI states associated with the FD symbols and the non-FD symbols. The FD symbols and the non-FD symbols are associated with a set of CCs in a CC list. The method 2900 further includes obtaining the one or more uplink channels on the FD symbols and the non-FD symbols associated with the TCI states activated or indicated by the MAC-CE.

In certain aspects, the method 2900 further includes outputting, via a MAC-CE or a DCI, separate uplink TCI states associated with the FD symbols and the non-FD symbols. The method 2900 further includes obtaining the one or more uplink channels on the FD symbols and the non-FD symbols associated with the separate uplink TCI states obtained via the MAC-CE or the DCI.

In certain aspects, the method 2900 further includes obtaining capability information indicating a capability to support separate power control parameters with a same beam associated with the FD symbols and the non-FD symbols. The method 2800 further includes outputting the one or more transmission parameters in accordance with the capability information.

In certain aspects, the method 2900 further includes obtaining capability information indicating a capability to support separate power control parameters with a same downlink TCI state and separate uplink TCI states associated with the FD symbols and the non-FD symbols. The method 2900 further includes outputting the one or more transmission parameters in accordance with the capability information.

In certain aspects, the method 2900 further includes obtaining capability information indicating a capability to support separate power control parameters with separate downlink and uplink TCI states associated with the FD symbols and the non-FD symbols. The method 2900 further includes outputting the one or more transmission parameters in accordance with the capability information.

In certain aspects, the method 2900 further includes outputting a sTRP unified TCI framework configuration and a mTRP unified TCI framework configuration. The method 2900 further includes obtaining the capability information in accordance with the sTRP unified TCI framework configuration or the mTRP unified TCI framework configuration.

In certain aspects, the method 2900 further includes obtaining capability information indicating a capability to support a quantity of at least one of: downlink TCI states, uplink TCI states, or joint uplink and downlink TCI states, per at least one of the FD symbols or the non-FD symbols, per CC or across multiple CCs. The method 2900 further includes outputting the one or more transmission parameters in accordance with the capability information.

In one aspect, the method 2900, or any aspect related to it, may be performed by an apparatus, such as a communications device 3100 of FIG. 31, which includes various components operable, configured, or adapted to perform the method 2900. The communications device 3100 is described below in further detail.

Note that FIG. 29 is just one example of a method, and other methods including fewer, additional, or alternative steps are possible consistent with this disclosure.

### Example Communications Devices

FIG. 30 depicts aspects of an example communications device 3000. In some aspects, communications device 3000 is a user equipment (UE), such as UE 104 described above with respect to FIG. 1 and FIG. 3.

The communications device 3000 includes a processing system 3005 coupled to a transceiver 3045 (e.g., a transmitter and/or a receiver). The transceiver 3045 is configured to transmit and receive signals for the communications device 3000 via an antenna 3050, such as the various signals as described herein. The processing system 3005 may be configured to perform processing functions for the communications device 3000, including processing signals received and/or to be transmitted by the communications device 3000.

The processing system 3005 includes one or more processors 3010. In various aspects, the one or more processors 3010 may be representative of one or more of receive processor 358, transmit processor 364, TX MIMO processor 366, and/or controller/processor 380, as described with respect to FIG. 3. The one or more processors 3010 are coupled to a computer-readable medium/memory 3025 via a bus 3040. In certain aspects, the computer-readable medium/memory 3025 is configured to store instructions (e.g., computer-executable code) that when executed by the one or more processors 3010, cause the one or more processors 3010 to perform the method 2800 described with respect to FIG. 28, and/or any aspect related to it. Note that reference to a processor performing a function of communications device 3000 may include the one or more processors 3010 performing that function of communications device 3000.

In the depicted example, computer-readable medium/memory 3025 stores code (e.g., executable instructions), such as code for outputting 3035 and code for obtaining 3030. Processing of the code for outputting 3035 and the code for obtaining 3030 may cause the communications device 3000 to perform the method 2800 described with respect to FIG. 28, and/or any aspect related to it.

The one or more processors 3010 include circuitry configured to implement (e.g., execute) the code stored in the computer-readable medium/memory 3025, including circuitry such as circuitry for outputting 3020 and circuitry for obtaining 3015. Processing with the circuitry for outputting 3020 and the circuitry for obtaining 3015 may cause the communications device 3000 to perform the method 2800 described with respect to FIG. 28, and/or any aspect related to it.

Various components of the communications device 3000 may provide means for performing the method 2800 described with respect to FIG. 28, and/or any aspect related to it.

Means for transmitting, sending or outputting (e.g., for transmission) may include transceivers 354 and/or antenna(s) 352 of the UE 104 illustrated in FIG. 3 and/or the code for outputting 3035, the circuitry for outputting 3020, the transceiver 3045 and the antenna 3050 of the communications device 3000 in FIG. 30.

Means for receiving or obtaining may include transceivers 354 and/or antenna(s) 352 of the UE 104 illustrated in FIG. 3 and/or the code for obtaining 3030, the circuitry for obtaining 3015, the transceiver 3045 and the antenna 3050 of the communications device 3000 in FIG. 30.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 30 is an example, and many other examples and configurations of communication device 3000 are possible.

FIG. 31 depicts aspects of an example communications device 3100. In some aspects, communications device 3100 is a network entity, such as BS 102 of FIG. 1 and FIG. 3, or a disaggregated base station as discussed with respect to FIG. 2.

The communications device 3100 includes a processing system 3105 coupled to a transceiver 3155 (e.g., a transmitter and/or a receiver) and/or a network interface 3165. The transceiver 3155 is configured to transmit and receive signals for the communications device 3100 via an antenna 3160, such as the various signals as described herein. The network interface 3165 is configured to obtain and send signals for the communications device 3100 via communication link(s), such as a backhaul link, midhaul link, and/or front haul link as described herein, such as with respect to FIG. 2. The processing system 3105 may be configured to perform processing functions for the communications device 3100, including processing signals received and/or to be transmitted by the communications device 3100.

The processing system 3105 includes one or more processors 3110. In various aspects, one or more processors 3110 may be representative of one or more of receive processor 338, transmit processor 320, TX MIMO processor 330, and/or controller/processor 340, as described with respect to FIG. 3. The one or more processors 3110 are coupled to a computer-readable medium/memory 3130 via a bus 3150. In certain aspects, the computer-readable medium/memory 3130 is configured to store instructions (e.g., computer-executable code) that when executed by the one or more processors 3110, cause the one or more processors 3110 to perform the method 2900 described with respect to FIG. 29, or any aspect related to it. Note that reference to a processor of communications device 3100 performing a function may include the one or more processors 3110 of communications device 3100 performing that function.

In the depicted example, the computer-readable medium/memory 3130 stores code (e.g., executable instructions), such as code for obtaining 3140 and code for outputting 3135. The computer-readable medium/memory 3130 may also store code for configuring (not shown). Processing of the code for obtaining 3140, the code for outputting 3135, and the code for configuring may cause the communications device 3100 to perform the method 2900 described with respect to FIG. 29, or any aspect related to it.

The one or more processors 3110 include circuitry configured to implement (e.g., execute) the code stored in the computer-readable medium/memory 3130, including circuitry such as circuitry for obtaining 3120, circuitry for outputting 3115, and circuitry for configuring (not shown). Processing with the circuitry for obtaining 3120, the circuitry for outputting 3115, and the circuitry for configuring may cause the communications device 3100 to perform the method 2900 described with respect to FIG. 29, or any aspect related to it.

Various components of the communications device 3100 may provide means for performing the method 2900 described with respect to FIG. 29, or any aspect related to it.

Means for transmitting, sending or outputting for transmission may include transceivers 332 and/or antenna(s) 334 of the BS 102 illustrated in FIG. 3 and/or the circuitry for outputting 3115, the code for outputting 3135, the transceiver 3155 and the antenna 3160 of the communications device 3100 in FIG. 31.

Means for receiving or obtaining may include transceivers 332 and/or antenna(s) 334 of the BS 102 illustrated in FIG. 3 and/or the circuitry for obtaining 3120, the code for obtaining 3140, the transceiver 3155 and the antenna 3160 of the communications device 3100 in FIG. 31.

Means for configuring may include processors 340, transceivers 332 and/or antenna(s) 334 of the BS 102 illustrated in FIG. 3 and/or the circuitry for configuring, the code for configuring, the processors 3110, the transceiver 3155 and the antenna 3160 of the communications device 3100 in FIG. 31.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 31 is an example, and many other examples and configurations of communication device 3100 are possible.

### Example Clauses

Implementation examples are described in the following numbered clauses:

Clause 1: A method for wireless communications at a wireless node, comprising: obtaining a configuration indicating one or more transmission parameters associated with full duplex (FD) symbols and non-FD symbols, wherein the one or more transmission parameters indicate at least one of: power control parameters or a unified transmission configuration indicator (TCI); and outputting one or more uplink channels for transmission, in accordance with the obtained configuration.

Clause 2: The method of clause 1, wherein at least one of: the FD symbols comprise sub-band full duplex (SBFD) symbols and the non-FD symbols comprise non-SBFD symbols; the unified TCI indicates a joint uplink and downlink TCI state or separate uplink and downlink TCI states; or the power control parameters comprise at least one of a received power target value, a power control factor value, or a closed-loop power control value.

Clause 3: The method of any one of clauses 1-2, wherein: the one or more transmission parameters further indicate different sets of the power control parameters; and the one or more uplink channels are outputted for transmission via the FD symbols and via the non-FD symbols in accordance with the different sets of the power control parameters.

Clause 4: The method of any one of clauses 1-2, wherein: the one or more transmission parameters further indicate a single set of the power control parameters and a power control offset value; and the one or more uplink channels are outputted for transmission via the FD symbols in accordance with the single set of the power control parameters and via the non-FD symbols in accordance with the single set of the power control parameters and the power control offset value.

Clause 5: The method of any one of clauses 1-4, further comprising obtaining a medium access control—control element (MAC-CE) or a downlink control information (DCI) indicating an adjustment of a power control offset value that indicates a difference between a first transmission power value associated with the FD symbols and a second transmission power value associated with the non-FD symbols.

Clause 6: The method of any one of clauses 1-5, wherein: the one or more transmission parameters further indicate a same downlink and uplink beam associated with the FD symbols and the non-FD symbols; and the one or more uplink channels are outputted for transmission via the FD symbols and via the non-FD symbols by using the same downlink and uplink beam.

Clause 7: The method of any one of clauses 1-6, wherein: the one or more transmission parameters further indicate at least one of: separate downlink beams respectively associated with the FD symbols and the non-FD symbols or separate uplink beams respectively associated with the FD symbols and the non-FD symbols; and the one or more uplink channels are outputted for transmission via the FD symbols and via the non-FD symbols by using the at least one of the separate downlink beams or the separate uplink beams.

Clause 8: The method of any one of clauses 1-7, wherein the one or more transmission parameters further indicate different TCI state types associated with the FD symbols and the non-FD symbols.

Clause 9: The method of clause 8, wherein each of the different TCI state types indicates separate uplink and downlink TCI states or a joint uplink and downlink TCI state.

Clause 10: The method of clause 9, wherein at least one of: the separate uplink and downlink TCI states indicate an uplink TCI state and a downlink TCI state; the joint uplink and downlink TCI state and the downlink TCI state are associated with different TCI pools; or the joint uplink and downlink TCI state and the downlink TCI state are associated with a same TCI pool.

Clause 11: The method of any one of clauses 1-10, wherein the one or more transmission parameters further indicate a same TCI state type, and wherein the same TCI state type indicates separate uplink and downlink TCI states.

Clause 12: The method of any one of clauses 1-11, further comprising obtaining a radio resource control (RRC) message indicating multiple TCI pools associated with multiple TCI states associated with the FD symbols and the non-FD symbols.

Clause 13: The method of any one of clauses 1-12, further comprising obtaining different medium access control—control elements (MAC-CEs) to activate or indicate different TCI states associated with at least one of the FD symbols or the non-FD symbols.

Clause 14: The method of clause 13, wherein a value of a first reserved bit in each of the different MAC-CEs indicates that a particular MAC-CE is to activate or indicate the different TCI states associated with the at least one of the FD symbols or the non-FD symbols.

Clause 15: The method of clause 13, wherein a value of a second reserved bit in each of the different MAC-CEs indicates that the different TCI states are associated with a joint TCI pool that is common to a set of different joint uplink and downlink TCI states or a separate TCI pool that is common to a set of different uplink states or a set of different downlink TCI states.

Clause 16: The method of any one of clauses 1-15, wherein at least one of: the configuration is obtained via a downlink control information (DCI) message; the one or more transmission parameters further indicate different power control parameters associated with different uplink channels; or the different uplink channels are outputted in accordance with the different power control parameters.

Clause 17: The method of any one of clauses 1-16, further comprising obtaining a single medium access control—control element (MAC-CE) to activate or indicate different TCI states associated with at least one of the FD symbols or the non-FD symbols.

Clause 18: The method of clause 17, wherein the single MAC-CE comprises a bit field per TCI code point, and wherein the bit field indicates that the different TCI states corresponding to the TCI code point are associated with the FD symbols or the non-FD symbols.

Clause 19: The method of any one of clauses 1-18, further comprising outputting capability information indicating a capability to support a single medium access control—control element (MAC-CE) that is configured to activate sixteen TCI states associated with at least one of the FD symbols or the non-FD symbols, wherein first eight TCI states are associated with the FD symbols and other eight TCI states are associated with the non-FD symbols; and obtaining the single MAC-CE, in accordance with the capability information.

Clause 20: The method of any one of clauses 1-19, further comprising obtaining a medium access control—control element (MAC-CE) to activate or indicate different TCI states associated with at least one of the FD symbols or the non-FD symbols, wherein a value of a reserved bit in the MAC-CE indicates that the MAC-CE comprises the different TCI states associated with the FD symbols or the TCI states associated with FD symbols and the non-FD symbols.

Clause 21: The method of clause 20, wherein: a first value of the reserved bit in the MAC-CE indicates that the MAC-CE is applicable to the different TCI states associated with the FD symbols; and a second value of the reserved bit in the MAC-CE indicates that the MAC-CE is applicable to the different TCI states associated with the FD symbols and the non-FD symbols.

Clause 22: The method of any one of clauses 1-20, further comprising obtaining a medium access control—control element (MAC-CE) to activate or indicate different TCI states associated with at least one of the FD symbols or the non-FD symbols, the MAC-CE having a multi downlink control information (mDCI)-based multi transmit receive point (mTRP) MAC-CE format.

Clause 23: The method of clause 22, wherein a value of a control resource set (CORESET) pool identification (ID) field in the MAC-CE indicates that the different TCI states are associated with the FD symbols or the non-FD symbols.

Clause 24: The method of clause 22, wherein a first value of a control resource set (CORESET) pool ID field in the MAC-CE indicates that the different TCI states are associated with the FD symbols and a second value of the CORESET pool ID field in the MAC-CE indicates that the different TCI states are associated with the non-FD symbols.

Clause 25: The method of any one of clauses 1-24, further comprising obtaining a medium access control—control element (MAC-CE) to activate or indicate joint uplink and downlink TCI states associated with at least one of the FD symbols or the non-FD symbols, the MAC-CE having a single downlink control information (sDCI)-based multi transmit receive point (mTRP) MAC-CE format.

Clause 26: The method of clause 25, wherein a value of a field in the MAC-CE indicates that the joint uplink and downlink TCI states are associated with the FD symbols or the non-FD symbols.

Clause 27: The method of clause 25, wherein a first value of a field in the MAC-CE indicates that the joint uplink and downlink TCI states are associated with the FD symbols and a second value of the field in the MAC-CE indicates that the joint uplink and downlink TCI states are associated with the non-FD symbols.

Clause 28: The method of any one of clauses 1-27, further comprising obtaining a medium access control—control element (MAC-CE) to activate or indicate separate uplink and downlink TCI states associated with at least one of the FD symbols or the non-FD symbols, the MAC-CE having a single downlink control information (sDCI)-based multi transmit receive point (mTRP) MAC-CE format.

Clause 29: The method of clause 28, wherein: a value of a first field in the MAC-CE indicates that uplink TCI states are associated with the FD symbols or the non-FD symbols; and a value of a second field in the MAC-CE indicates that downlink TCI states are associated with the FD symbols or the non-FD symbols.

Clause 30: The method of any one of clauses 1-29, further comprising obtaining a medium access control—control element (MAC-CE) or a downlink control information (DCI) to activate or indicate TCI states associated with the FD symbols and the non-FD symbols, the FD symbols and the non-FD symbols being associated with a set of component carriers (CCs) in a CC list.

Clause 31: The method of any one of clauses 1-30, further comprising obtaining, via a medium access control—control element (MAC-CE) or a downlink control information (DCI), separate uplink TCI states associated with the FD symbols and the non-FD symbols.

Clause 32: The method of any one of clauses 1-31, further comprising: outputting capability information indicating a capability to support separate power control parameters with a same beam associated with the FD symbols and the non-FD symbols, wherein: the one or more transmission parameters are based on the capability information.

Clause 33: The method of any one of clauses 1-32, further comprising: outputting capability information indicating a capability to support separate power control parameters with a same downlink TCI state and separate uplink TCI states associated with the FD symbols and the non-FD symbols, wherein: the one or more transmission parameters are based on the capability information.

Clause 34: The method of any one of clauses 1-33, further comprising: outputting capability information indicating a capability to support separate power control parameters with separate downlink and uplink TCI states associated with the FD symbols and the non-FD symbols, wherein: the one or more transmission parameters are based on the capability information.

Clause 35: The method of clause 34, further comprising: obtaining at least one of: obtaining a single transmit receive point TRP (sTRP) unified TCI framework configuration and outputting the capability information in accordance with the sTRP unified TCI framework configuration, or obtaining a multiple TRP (mTRP) unified TCI framework configuration and outputting the capability information in accordance with the mTRP unified TCI framework configuration.

Clause 36: The method of any one of clauses 1-35, further comprising: outputting capability information indicating a capability to support a quantity of at least one of: downlink TCI states, uplink TCI states, or joint uplink and downlink TCI states, per at least one of the FD symbols or the non-FD symbols, per component carrier (CC) or across multiple CCs, wherein: the one or more transmission parameters are based on the capability information.

Clause 37: A method for wireless communications at a wireless node, comprising: outputting a configuration indicating one or more transmission parameters associated with full duplex (FD) symbols and non-FD symbols, wherein the one or more transmission parameters indicate at least one of: power control parameters or a unified transmission configuration indicator (TCI); and obtaining one or more uplink channels, in accordance with the outputted configuration.

Clause 38: The method of clause 37, wherein at least one of: the FD symbols comprise sub-band full duplex (SBFD) symbols and the non-FD symbols comprise non-SBFD symbols; the unified TCI indicates a joint uplink and downlink TCI state or separate uplink and downlink TCI states; or the power control parameters comprise at least one of a received power target value, a power control factor value, or a closed-loop power control value.

Clause 39: The method of any one of clauses 37-38, further comprising: outputting a medium access control—control element (MAC-CE) or a downlink control information (DCI) indicating an adjustment of a power control offset value that indicates a difference between a first transmission power value associated with the FD symbols and a second transmission power value associated with the non-FD symbols, wherein: the one or more uplink channels are obtained, in accordance with the adjusted power control offset value.

Clause 40: The method of any one of clauses 37-39, further comprising: configuring multiple TCI pools under a first component carrier (CC) of a set of CCs, wherein the multiple TCI pools are associated with multiple TCI states associated with the FD symbols and the non-FD symbols; and outputting a radio resource control (RRC) message indicating the multiple TCI pools.

Clause 41: The method of any one of clauses 37-40, further comprising outputting different medium access control—control elements (MAC-CEs) to activate or indicate different TCI states associated with at least one of the FD symbols or the non-FD symbols.

Clause 42: The method of clause 41, wherein a value of a first reserved bit in each of the different MAC-CEs indicates that the particular MAC-CE is to activate or indicate the different TCI states associated with the at least one of the FD symbols or the non-FD symbols.

Clause 43: The method of clause 41, wherein a value of a second reserved bit in each of the different MAC-CEs indicates that the different TCI states are associated with a joint TCI pool that is common to a set of different joint uplink and downlink TCI states or a separate TCI pool that is common to a set of different uplink states or a set of different downlink TCI states.

Clause 44: The method of clause 37, further comprising outputting a single medium access control—control element (MAC-CE) to activate or indicate different TCI states associated with at least one of the FD symbols or the non-FD symbols.

Clause 45: The method of clause 44, wherein the single MAC-CE comprises a bit field per TCI code point, and wherein the bit field indicates that the different TCI states corresponding to the TCI code point are associated with the FD symbols or the non-FD symbols.

Clause 46: The method of any one of clauses 37-45, further comprising: obtaining capability information to support a single medium access control—control element (MAC-CE) that is configured to activate sixteen TCI states associated with at least one of the FD symbols or the non-FD symbols, wherein first eight TCI states are associated with the FD symbols and other eight TCI states are associated with the non-FD symbols; and outputting the single MAC-CE, in accordance with the capability information.

Clause 47: The method of any one of clauses 37-46, further comprising outputting a medium access control—control element (MAC-CE) to activate or indicate different TCI states associated with at least one of the FD symbols or the non-FD symbols, wherein a value of a reserved bit in the MAC-CE indicates that the MAC-CE comprises the different TCI states associated with the FD symbols or the TCI states associated with FD symbols and the non-FD symbols.

Clause 48: The method of clause 47, wherein: a first value of the reserved bit in the MAC-CE indicates that the MAC-CE is applicable to the different TCI states associated with the FD symbols; and a second value of the reserved bit in the MAC-CE indicates that the MAC-CE is applicable to the different TCI states associated with the FD symbols and the non-FD symbols.

Clause 49: The method of any one of clauses 37-48, further comprising outputting a medium access control—control element (MAC-CE) to activate or indicate different TCI states associated with at least one of the FD symbols or the non-FD symbols, the MAC-CE having a multi downlink control information (mDCI)-based multi transmit receive point (mTRP) MAC-CE format.

Clause 50: The method of clause 49, wherein a value of a control resource set (CORESET) pool identification (ID) field in the MAC-CE indicates that the different TCI states are associated with the FD symbols or the non-FD symbols.

Clause 51: The method of clause 49, wherein a first value of a control resource set (CORESET) pool ID field in the MAC-CE indicates that the different TCI states are associated with the FD symbols and a second value of the CORESET pool ID field in the MAC-CE indicates that the different TCI states are associated with the non-FD symbols.

Clause 52: The method of any one of clauses 37-51, further comprising outputting a medium access control—control element (MAC-CE) to activate or indicate joint uplink and downlink TCI states associated with at least one of the FD symbols or the non-FD symbols, the MAC-CE having a single downlink control information (sDCI)-based multi transmit receive point (mTRP) MAC-CE format.

Clause 53: The method of clause 52, wherein a value of a field in the MAC-CE indicates that the joint uplink and downlink TCI states are associated with the FD symbols or the non-FD symbols.

Clause 54: The method of clause 52, wherein a first value of a field in the MAC-CE indicates that the joint uplink and downlink TCI states are associated with the FD symbols and a second value of the field in the MAC-CE indicates that the joint uplink and downlink TCI states are associated with the non-FD symbols.

Clause 55: The method of any one of clauses 37-54, further comprising outputting a medium access control—control element (MAC-CE) to activate or indicate separate uplink and downlink TCI states associated with at least one of the FD symbols or the non-FD symbols, the MAC-CE having a single downlink control information (sDCI)-based multi transmit receive point (mTRP) MAC-CE format.

Clause 56: The method of clause 55, wherein: a value of a first field in the MAC-CE indicates that uplink TCI states are associated with the FD symbols or the non-FD symbols; and a value of a second field in the MAC-CE indicates that downlink TCI states are associated with the FD symbols or the non-FD symbols.

Clause 57: The method of any one of clauses 37-56, further comprising outputting a medium access control—control element (MAC-CE) or a downlink control information (DCI) to activate or indicate TCI states associated with the FD symbols and the non-FD symbols, the FD symbols and the non-FD symbols being associated with a set of component carriers (CCs) in a CC list.

Clause 58: The method of any one of clauses 37-57, further comprising outputting, via a medium access control—control element (MAC-CE) or a downlink control information (DCI), separate uplink TCI states associated with the FD symbols and the non-FD symbols.

Clause 59: An apparatus, comprising: at least one memory comprising instructions; and one or more processors configured, individually or in any combination, to execute the instructions and cause the apparatus to perform a method in accordance with any one of Clauses 1-58.

Clause 60: An apparatus, comprising means for performing a method in accordance with any one of Clauses 1-58.

Clause 61: A non-transitory computer-readable medium comprising executable instructions that, when executed by one or more processors of an apparatus, cause the apparatus to perform a method in accordance with any one of Clauses 1-58.

Clause 62: A computer program product embodied on a computer-readable storage medium comprising code for performing a method in accordance with any one of Clauses 1-58.

Clause 63: A user equipment (UE), comprising: at least one transceiver; at least one memory comprising instructions; and one or more processors, individually or collectively, configured to execute the instructions and cause the UE to perform a method in accordance with any one of clauses 1-36, wherein the at least one transceiver is configured to at least receive the configuration and transmit the one or more uplink channels.

Clause 64: A network entity, comprising: at least one transceiver; at least one memory comprising instructions; and one or more processors, individually or collectively, configured to execute the instructions and cause the network entity to perform a method in accordance with any one of clauses 37-58, wherein the at least one transceiver is configured to at least transmit the configuration and receive the one or more uplink channels.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
at least one memory comprising instructions; and
one or more processors, individually or collectively, configured to execute the instructions and cause the apparatus to:
obtain a configuration indicating one or more transmission parameters associated with full duplex (FD) symbols and non-FD symbols, wherein the one or more transmission parameters indicate at least one of: power control parameters or a unified transmission configuration indicator (TCI); and
output one or more uplink channels for transmission, in accordance with the obtained configuration.

2. The apparatus of claim 1, wherein at least one of:
the FD symbols comprise sub-band full duplex (SBFD) symbols and the non-FD symbols comprise non-SBFD symbols;
the unified TCI indicates a joint uplink and downlink TCI state or separate uplink and downlink TCI states; or
the power control parameters comprise at least one of a received power target value, a power control factor value, or a closed-loop power control value.

3. The apparatus of claim 1, wherein:
the one or more transmission parameters further indicate different sets of the power control parameters; and
the one or more uplink channels are outputted for transmission via the FD symbols and via the non-FD symbols in accordance with the different sets of the power control parameters.

4. The apparatus of claim 1, wherein:
the one or more transmission parameters further indicate a single set of the power control parameters and a power control offset value; and
the one or more uplink channels are outputted for transmission via the FD symbols in accordance with the single set of the power control parameters and via the non-FD symbols in accordance with the single set of the power control parameters and the power control offset value.

5. The apparatus of claim 1, wherein:
the one or more transmission parameters further indicate a same downlink and uplink beam associated with the FD symbols and the non-FD symbols; and
the one or more uplink channels are outputted for transmission via the FD symbols and via the non-FD symbols by using the same downlink and uplink beam.

6. The apparatus of claim 1, wherein:
the one or more transmission parameters further indicate at least one of: separate downlink beams respectively associated with the FD symbols and the non-FD symbols or separate uplink beams respectively associated with the FD symbols and the non-FD symbols; and
the one or more uplink channels are outputted for transmission via the FD symbols and via the non-FD symbols by using the at least one of the separate downlink beams or the separate uplink beams.

7. The apparatus of claim 1, wherein the one or more transmission parameters further indicate different TCI state types associated with the FD symbols and the non-FD symbols.

8. The apparatus of claim 7, wherein each of the different TCI state types indicates separate uplink and downlink TCI states or a joint uplink and downlink TCI state.

9. The apparatus of claim 8, wherein at least one of:
the separate uplink and downlink TCI states indicate an uplink TCI state and a downlink TCI state;
the joint uplink and downlink TCI state and the downlink TCI state are associated with different TCI pools; or
the joint uplink and downlink TCI state and the downlink TCI state are associated with a same TCI pool.

10. The apparatus of claim 1, wherein the one or more transmission parameters further indicate a same TCI state type, and wherein the same TCI state type indicates separate uplink and downlink TCI states.

11. The apparatus of claim 1, wherein at least one of:
the configuration is obtained via a downlink control information (DCI) message;
the one or more transmission parameters further indicate different power control parameters associated with different uplink channels; or
the different uplink channels are outputted in accordance with the different power control parameters.

12. The apparatus of claim 1, wherein:
the one or more processors, individually or collectively, are configured to execute the instructions and cause the apparatus to output capability information indicating a capability to support separate power control parameters with a same beam associated with the FD symbols and the non-FD symbols; and
the one or more transmission parameters are based on the capability information.

13. The apparatus of claim 1, wherein:
the one or more processors, individually or collectively, are configured to execute the instructions and cause the apparatus to output capability information indicating a capability to support separate power control parameters with a same downlink TCI state and separate uplink TCI states associated with the FD symbols and the non-FD symbols; and
the one or more transmission parameters are based on the capability information.

14. The apparatus of claim 1, wherein:
the one or more processors, individually or collectively, are configured to execute the instructions and cause the apparatus to output capability information indicating a capability to support separate power control parameters with separate downlink and uplink TCI states associated with the FD symbols and the non-FD symbols; and
the one or more transmission parameters are based on the capability information.

15. The apparatus of claim 14, wherein the one or more processors, individually or collectively, are configured to execute the instructions and cause the apparatus to at least one of:
obtain a single transmit receive point TRP (sTRP) unified TCI framework configuration and output the capability information in accordance with the sTRP unified TCI framework configuration; or
obtain a multiple TRP (mTRP) unified TCI framework configuration and output the capability information in accordance with the mTRP unified TCI framework configuration.

16. The apparatus of claim 1, wherein:
the one or more processors, individually or collectively, are configured to execute the instructions and cause the apparatus to output capability information indicating a capability to support a quantity of at least one of: downlink TCI states, uplink TCI states, or joint uplink and downlink TCI states, per at least one of the FD symbols or the non-FD symbols, per component carrier (CC) or across multiple CCs; and
the one or more transmission parameters are based on the capability information.

17. The apparatus of claim 1, further comprising at least one transceiver configured to receive the configuration and transmit the one or more uplink channels, wherein the apparatus is configured as a user equipment (UE).

18. An apparatus for wireless communications, comprising:
at least one memory comprising instructions; and
one or more processors, individually or collectively, configured to execute the instructions and cause the apparatus to:
output a configuration indicating one or more transmission parameters associated with full duplex (FD) symbols and non-FD symbols, wherein the one or more transmission parameters indicate at least one of: power control parameters or a unified transmission configuration indicator (TCI); and
obtain one or more uplink channels, in accordance with the outputted configuration.

19. The apparatus of claim 18, wherein at least one of:
the FD symbols comprise sub-band full duplex (SBFD) symbols and the non-FD symbols comprise non-SBFD symbols;
the unified TCI indicates a joint uplink and downlink TCI state or separate uplink and downlink TCI states; or
the power control parameters comprise at least one of a received power target value, a power control factor value, or a closed-loop power control value.

20. The apparatus of claim 18, wherein:
the one or more processors, individually or collectively, are configured to execute the instructions and cause the apparatus to output a medium access control—control element (MAC-CE) or a downlink control information (DCI) indicating an adjustment of a power control offset value that indicates a difference between a first transmission power value associated with the FD symbols and a second transmission power value associated with the non-FD symbols, wherein:
the one or more uplink channels are obtained, in accordance with the adjusted power control offset value.

21. The apparatus of claim 18, wherein the one or more processors, individually or collectively, are configured to execute the instructions and cause the apparatus to:
configure multiple TCI pools under a first component carrier (CC) of a set of CCs, wherein the multiple TCI pools are associated with multiple TCI states associated with the FD symbols and the non-FD symbols; and
output a radio resource control (RRC) message indicating the multiple TCI pools.

22. The apparatus of claim 18, wherein the one or more processors, individually or collectively, are configured to execute the instructions and cause the apparatus to output different medium access control—control elements (MAC-CEs) to activate or indicate different TCI states associated with at least one of the FD symbols or the non-FD symbols.

23. The apparatus of claim 22, wherein a value of a first reserved bit in each of the different MAC-CEs indicates that a particular MAC-CE is to activate or indicate the different TCI states associated with the at least one of the FD symbols or the non-FD symbols.

24. The apparatus of claim 22, wherein a value of a second reserved bit in each of the different MAC-CEs indicates that the different TCI states are associated with a joint TCI pool that is common to a set of different joint uplink and downlink TCI states or a separate TCI pool that is common to a set of different uplink states or a set of different downlink TCI states.

25. The apparatus of claim 18, wherein the one or more processors, individually or collectively, are configured to execute the instructions and cause the apparatus to output a single medium access control—control element (MAC-CE) to activate or indicate different TCI states associated with at least one of the FD symbols or the non-FD symbols.

26. The apparatus of claim 25, wherein the single MAC-CE comprises a bit field per TCI code point, and wherein the bit field indicates that the different TCI states corresponding to the TCI code point are associated with the FD symbols or the non-FD symbols.

27. The apparatus of claim 18, wherein the one or more processors, individually or collectively, are configured to execute the instructions and cause the apparatus to:
obtain capability information to support a single medium access control—control element (MAC-CE) that is configured to activate sixteen TCI states associated with at least one of the FD symbols or the non-FD symbols, wherein first eight TCI states are associated with the FD symbols and other eight TCI states are associated with the non-FD symbols; and
output the single MAC-CE, in accordance with the capability information.

28. The apparatus of claim 18, wherein the one or more processors, individually or collectively, are configured to execute the instructions and cause the apparatus to output a medium access control—control element (MAC-CE) to activate or indicate different TCI states associated with at least one of the FD symbols or the non-FD symbols, wherein a value of a reserved bit in the MAC-CE indicates that the MAC-CE comprises the different TCI states associated with the FD symbols or the TCI states associated with FD symbols and the non-FD symbols.

29. The apparatus of claim 28, wherein:
a first value of the reserved bit in the MAC-CE indicates that the MAC-CE is applicable to the different TCI states associated with the FD symbols; and
a second value of the reserved bit in the MAC-CE indicates that the MAC-CE is applicable to the different TCI states associated with the FD symbols and the non-FD symbols.

30. The apparatus of claim 18, wherein the one or more processors, individually or collectively, are configured to execute the instructions and cause the apparatus to output a medium access control—control element (MAC-CE) to activate or indicate different TCI states associated with at least one of the FD symbols or the non-FD symbols, the MAC-CE having a multi downlink control information (mDCI)-based multi transmit receive point (mTRP) MAC-CE format.

31. The apparatus of claim 30, wherein a value of a control resource set (CORESET) pool identification (ID) field in the MAC-CE indicates that the different TCI states are associated with the FD symbols or the non-FD symbols.

32. The apparatus of claim 30, wherein a first value of a control resource set (CORESET) pool ID field in the MAC-CE indicates that the different TCI states are associated with the FD symbols and a second value of the CORESET pool ID field in the MAC-CE indicates that the different TCI states are associated with the non-FD symbols.

33. The apparatus of claim 18, wherein the one or more processors, individually or collectively, are configured to execute the instructions and cause the apparatus to output a medium access control—control element (MAC-CE) to activate or indicate joint uplink and downlink TCI states associated with at least one of the FD symbols or the non-FD symbols, the MAC-CE having a single downlink control information (sDCI)-based multi transmit receive point (mTRP) MAC-CE format.

34. The apparatus of claim 33, wherein a value of a field in the MAC-CE indicates that the joint uplink and downlink TCI states are associated with the FD symbols or the non-FD symbols.

35. The apparatus of claim 33, wherein a first value of a field in the MAC-CE indicates that the joint uplink and downlink TCI states are associated with the FD symbols and a second value of the field in the MAC-CE indicates that the joint uplink and downlink TCI states are associated with the non-FD symbols.

36. The apparatus of claim 18, wherein the one or more processors, individually or collectively, are configured to execute the instructions and cause the apparatus to output a medium access control—control element (MAC-CE) to activate or indicate separate uplink and downlink TCI states associated with at least one of the FD symbols or the non-FD symbols, the MAC-CE having a single downlink control information (sDCI)-based multi transmit receive point (mTRP) MAC-CE format.

37. The apparatus of claim 36, wherein:
a value of a first field in the MAC-CE indicates that uplink TCI states are associated with the FD symbols or the non-FD symbols; and
a value of a second field in the MAC-CE indicates that downlink TCI states are associated with the FD symbols or the non-FD symbols.

38. The apparatus of claim 18, wherein the one or more processors, individually or collectively, are configured to execute the instructions and cause the apparatus to output a medium access control—control element (MAC-CE) or a downlink control information (DCI) to activate or indicate TCI states associated with the FD symbols and the non-FD symbols, the FD symbols and the non-FD symbols being associated with a set of component carriers (CCs) in a CC list.

39. The apparatus of claim 18, wherein the one or more processors, individually or collectively, are configured to execute the instructions and cause the apparatus to output, via a medium access control—control element (MAC-CE) or a downlink control information (DCI), separate uplink TCI states associated with the FD symbols and the non-FD symbols.

40. The apparatus of claim 18, further comprising at least one transceiver configured to transmit the configuration and receive the one or more uplink channels, wherein the apparatus is configured as a network entity.

41. A method for wireless communications at a wireless node, comprising:
obtaining a configuration indicating one or more transmission parameters associated with full duplex (FD) symbols and non-FD symbols, wherein the one or more transmission parameters indicate at least one of: power control parameters or a unified transmission configuration indicator (TCI); and
outputting one or more uplink channels for transmission, in accordance with the obtained configuration.
